(19) United States
(12) Patent Application Publication
(10) Pub. No.: US 2011/0184813 A1
(43) Pub. Date: Jul. 28, 2011

(54) TARGETING OFFERS TO USERS OF A WEB SITE

(75) Inventors: Natalie Adams Barnes, Davie, FL (US); Stephanie Lone, Pompano Beach, FL (US); James Ketcham, Shelbyville, KY (US); William W. Graham, JR., Mill Valley, CA (US); Peter J. Offringa, Corte Madera, CA (US)

(73) Assignee: CBS Interactive, Inc.

(21) Appl. No.: 13/023,377

(22) Filed: Feb. 8, 2011

Related U.S. Application Data
(63) Continuation-in-part of application No. 12/559,455, filed on Sep. 14, 2009.

(51) Int. Cl. G06Q 30/00

(52) U.S. Cl. 705/14.66

(57) ABSTRACT

A computer system for targeting offers to users of a web site comprises a memory and a processing circuit. The memory is configured to store a plurality of user attributes for a user and a plurality of rules defining when an offer is to be presented to a user. The processing circuit is configured to transmit a web page to a client device, to receive user interaction data from the client device representing interaction with the web page, to update the user attributes stored in memory in response to the received user interaction data, to determine whether the updated user attributes satisfy a rule, and based on whether the updated user attributes meet the rule to transmit an offer to the client device for display on the web page or a next web page.

### CROSS-REFERENCE TO RELATED PATENT APPLICATIONS

This application is a continuation-in-part of U.S. application Ser. No. 12/559,455 filed Sep. 14, 2009, entitled “Systems and Methods for Delivering Targeted Content to a User” to Graham Jr. et al., which is herein incorporated by reference in its entirety.

### BACKGROUND

Users of the Internet access content from a variety of different websites. Conventionally, the web application that delivers a web page to the user is connected to memory that stores the content and business logic for the web page. Some websites separate the content and the business logic to generate the web page, allowing the web site to change its content more easily.

Some of these websites target offers to users based on information about the user. These websites typically require the user to create a user profile with relevant information about the user (e.g., the user's age, residence, interests and other identifying information). This information can then be used to deliver offers to users that meet certain criteria.

### SUMMARY

According to one exemplary embodiment, a computer system configured to target offers to users of a web site comprises a memory and a processing circuit. The memory is configured to store a plurality of user attributes for a user and a plurality of rules defining when an offer is to be presented to a user. The processing circuit is configured to transmit a web page to a client device, to receive user interaction data from the client device representing interaction with the web page, to update the user attributes stored in memory in response to the received user interaction data, to determine whether the updated user attributes satisfy a rule, and based on whether the updated user attributes meet the rule to transmit an offer to the client device for display on the web page or a next web page.

According to another exemplary embodiment, a computer system configured to target offers to users of a web site comprises a memory and a processing circuit. The memory is configured to store a plurality of user attributes for a user and a plurality of rules defining when an offer is to be presented to a user. The user attributes comprise demographic data for the user, session-based user data representing a current user session and historical information about the user. The processing circuit is configured to transmit a web page to a client device, to compare a rule to the demographic data, session-based user data and historical information to determine whether these user attributes meet a rule, and based on whether the user attributes meet the rule to transmit an offer to the client device for display on the web page.

According to another exemplary embodiment, a computer system configured to generate a rule-based marketing offer for a web site comprises a memory and a processing circuit. The processing circuit is configured to transmit to a client device a web page comprising fields for receiving an identification of a rule, customer segment identification, and an offer identification, to generate a module based on the received identifications and to store the module in association with a web page.

### BRIEF DESCRIPTION OF THE DRAWINGS

FIG. 1 is a schematic diagram of a network system according to one embodiment of the invention;

FIG. 2 is a block diagram of an exemplary system architecture according to one embodiment of the invention;

FIG. 3 is a detailed block diagram of the rules proxy according to one embodiment of the invention;

FIG. 4 is a flow diagram for a process for delivering targeted content to a user according to one embodiment of the invention;

FIG. 5 is a flow diagram for a detailed process for delivering targeted content to a user according to one embodiment of the invention;

FIG. 6 is a flow diagram for a detailed process for assigning a unique identifier to a user according to one embodiment of the invention; and

FIG. 7 is a block diagram of an exemplary computer system according to one embodiment of the invention.

FIG. 8 is a schematic diagram of an exemplary computer system or tool for creating a rule-based marketing offer for a web site.

FIG. 9 is a web page for use in an offer creation process, according to an exemplary embodiment.

FIG. 10 is a web 1000 for use in a rule creation process, according to an exemplary embodiment.

FIG. 11 is a web page for www.gamespot.com, showing an exemplary offer output in the form of an overlay.

FIG. 12 shows web pages illustrating an intercept offer output, according to an exemplary embodiment.

FIG. 13 is a web page for use in a marketing offer creation process, according to an exemplary embodiment.

FIG. 14 is a web page illustrating a marketing offer output, according to an exemplary embodiment.

FIG. 15 is a flow diagram illustrating a process of targeting offers to users of a web site, according to an exemplary embodiment.

FIG. 16 is a more detailed flow diagram of the process of targeting offers to users of a web site of FIG. 15.

FIG. 17 is a block diagram of a computer system for targeting offers to users of a web site, according to an exemplary embodiment.

FIG. 18 is a block diagram of an architecture for a user profile database, according to an exemplary embodiment.

FIG. 19 is a more detailed block diagram of one embodiment of the architecture of FIG. 18.

FIG. 20 is a flowchart of a method for providing an offer on a web page to a user, according to an exemplary embodiment.

FIG. 21 is an illustration of user profile data stored in a database, according to an exemplary embodiment.

FIG. 22 is an illustration of user profile data for a particular user, according to an exemplary embodiment.

FIG. 23 is an illustration of user profile data for a particular user, according to another exemplary embodiment.

FIG. 24 is a panel of user data, according to an exemplary embodiment.

FIG. 25 is a flowchart of a method of reporting user attributes by topic in a plurality of different topical reporting panels, according to an exemplary embodiment.

FIG. 26 is a flow diagram of a user profiling architecture, according to an exemplary embodiment.

### DETAILED DESCRIPTION OF EXEMPLARY EMBODIMENTS

Embodiments of the invention relate to an architectural stack including an asset real-time recommendation and optimization web proxy (ARROW, “Arrow” hereinafter) between a web server and an HTTP proxy cache. Arrow is a rules proxy. Arrow can be used to track a user's behavior as the user browses web properties on a web site. From the behavioral data collected, Arrow can determine the content that interests a particular user by running a set of rules using the user's behavior information when a page request is received. Based on the user's interests, Arrow can assign the user to one or more user segment groups or user buckets. The site applications can then use the user segment information to customize the web page based on the user's interests (e.g., serve targeted content and/or advertisements).

In one embodiment, Arrow is an HTTP proxy application that receives a user request to access a web page from the web server, captures user data (e.g., referrer data and/or session data) from the user request, applies a rule to the user data to assign the user to a user bucket(s), generates a web page with content using the assigned user bucket(s), and delivers the user-specific, generated web page to the user.

Advantages of embodiments of the invention include the ability to learn from a user's behavior in real-time (e.g., in the user's current browsing session). This allows the best possible content to be served to a given user. In addition, the rules can be programmed so that the user segment information can be used for a variety of applications. For example, Arrow can be used to determine that a user is interested in anti-virus software on download.com, but has not yet downloaded anything; targeted run-of-site ads can be sold to anti-virus companies for a larger premium for these users. In another example, Arrow can be used to determine that a user came to the site after searching for a given product on a search engine, such as Google; targeted ads can be sold for competitor's products to these types of users. In yet another example, the user experience can be personalized by recognizing that a user favors one site over another, and populating navigational elements accordingly. From how the user arrived on the site, Arrow can determine that they might be less inclined to turn or visit multiple pages than another user, which can be used to swap a page component that tends to drive user-engagement with another page component that drives more revenue. Arrow can also be used to perform multivariate testing to track which multivariate test groups the user is in, add the user to a new group if a new test is running, and the like.

Some embodiments may more intelligently serve surveys by targeting them based on user demographics instead of simply based on a percentage of users and/or whether a user has already received a survey based on cookie data. Some embodiments may trigger offers based on historical, demographics, and/or session data instead of merely session data only. Some embodiments may trigger offers for services instead of products. Some embodiments may provide real-time segmentation and targeting of users for specific offers based on real-time user interactions and changes in user attributes. Some embodiments may provide targeting of offers on a content web site instead of a product-only web site.

Some embodiments may extend the Arrow web proxy to make it internally open sourced (e.g., within an organization) to allow more users to create offers, rules, and marketing campaigns. Some embodiments may extend the Arrow web proxy to provide a dynamic data store or database and refreshing the data store so that rules can be deployed dynamically. Some embodiments may capture user data across different web sites (each having one or more web pages) operated by different business entities, to access demographic, registration, and other data stored individually at the different web sites.

Some embodiments may be used as a segmentation tool for an advertising team to learn more about their customers, for example without using the tool to serve offers to a web page. For example, the embodiments may be used to get a better understanding of how many users a particular rule might segment before a rule is used in a live web page.

Some embodiments can provide both real-time and historical attribute data for a given user ID in a much quicker response time than was previously available. Some embodiment can provide real-time attribute data for a given user ID based on live data as it is received from a web site. Some embodiments can record and report user attributes for a given user ID from among a large database of raw data about many users.

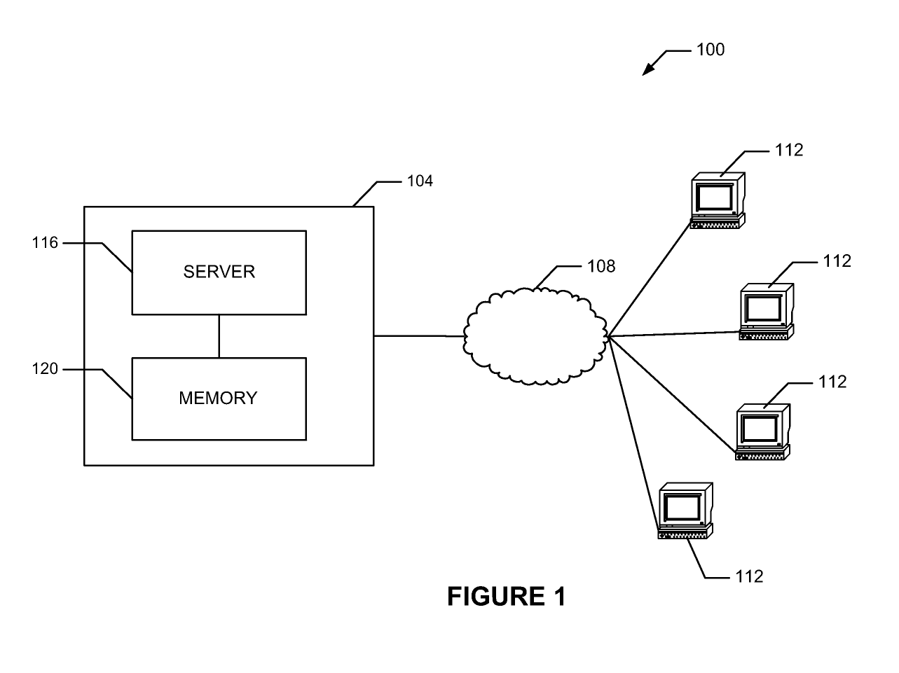

An embodiment of the invention will now be described in detail with reference to FIG. 1. FIG. 1 illustrates a web-based system 100 for delivering content to a user. The system 100 includes a host site 104 and a plurality of user systems 112 coupled via a network 108. The system 104 includes a server 116 and memory 120.

The host site 104 is connected to the plurality of user systems 112 over the network 108. The server 116 is in communication with the memory 120. The system 104 is typically a computer system having a processing circuit, and may be an HTTP (Hypertext Transfer Protocol) server (e.g., an Apache server provided by the Apache Software Foundation, Forest Hill, Md.). The processing circuit may comprise digital and/or analog electrical components (e.g., a microprocessor, application-specific integrated circuit, microcontroller, or other digital logic) configured to perform the functions described herein. The processing circuit may be a single server computer or a plurality of server computers, and may operate in a cloud computing environment, such as a shared, scalable computing environment. The memory 120 includes storage media, which may be volatile or non-volatile memory that includes, for example, read only memory (ROM), random access memory (RAM), magnetic disk storage media, optical storage media, flash memory devices and zip drives.

The network 108 is a local area network (LAN), wide area network (WAN), a telephone network, such as the Public Switched Telephone Network (PSTN), an intranet, the Internet, or combinations thereof. The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers.

When a user of one of the plurality of user systems 112 requests to access the server to view search results responsive to a search query, a request is communicated to the host site 104 over the network 108. For example, a signal is transmitted from one of the user systems 112, the signal having a destination address (e.g., address representing the search results page for the web site), a request (e.g., a request to view the requested page) and a return address (e.g., address representing user system that initiated the request). The request may include a cookie that includes data identifying the user and/or the user computer. The server 116 accesses the database 120 to provide the user with the requested web page, which is communicated to the user over the network 108. For example, another signal may be transmitted that includes a destination address corresponding to the return address of the client system, and a web page responsive to the request.

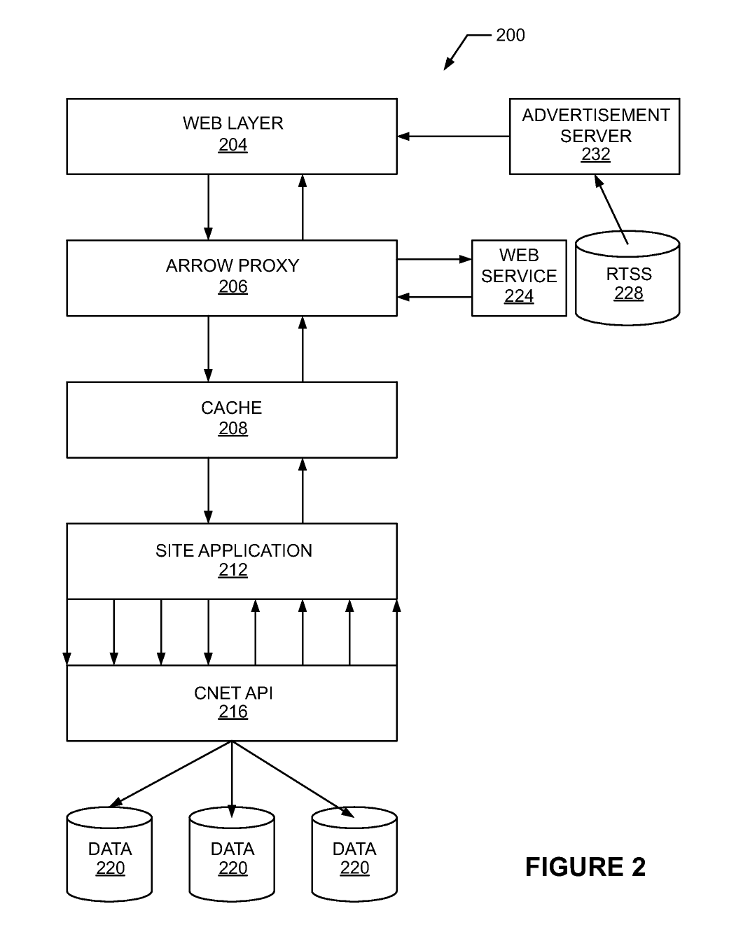

FIG. 2 illustrates an exemplary system architecture 200 at the server 104 according to one embodiment. It will be appreciated that the system architecture may be implemented as one server (e.g., server 104) or a plurality of servers in communication with one another.

As shown in FIG. 2, the system architecture 200 includes a web layer 204 (or web server), an arrow proxy 206, a cache 208, a site application 212, a data API (application programming interface) 216 and a plurality of data stores 220. The arrow proxy 206 is in communication with a web service 224 that is coupled to a real-time session store (RTSS) 228. An advertisement server 232 may also be in communication with the web layer 204 and the RTSS 228. It will be appreciated that the system architecture may vary from the illustrated architecture. For example, the web layer 204 may directly access the API 216 which accesses data stores 220, the system architecture 200 may not include the cache 208, etc., as will be appreciated by those skilled in the art.

The web layer 204 is configured to receive user requests to access content through a web browser and return content that is responsive to the user request. The web layer 204 communicates the user requests to the cache 208. In one embodiment, the web layer 204 is an Apache server.

The cache 208 is configured to temporarily store content that is accessed frequently by the web layer 204 and can be rapidly accessed by the web layer 204. In one embodiment, the cache 208 may be a caching proxy server. The cache 208 communicates the user requests to the site application 212.

The site application 212 is configured to update the cache 208 and to process user requests received from the web layer 204. The site application 212 may identify that the user request is for a page that includes data from multiple sources. The site application 212 can then convert the page request into a request for content from multiple sources and transmit these requests to the site API 216. The site application 212 may also include business logic that determines, for example, how to decorate the web page, the layout of the web page, components of the web page, and the like.

The data API 216 is configured to simultaneously access data from the plurality of data stores 220 to collect the data responsive to the plurality of requests from the site application 212. The plurality of data stores 220 include data about different sites owned by a company (e.g., download.com, cnet.com, tv.com, etc. owned by CBS Interactive) or are otherwise related.

The data in the data stores 220 is provided to the data API 216, which provides the content to the site application 212. The site application 212 updates the cache 208 and delivers the cached content in combination with the accessed content to the web layer 204, which delivers browsable content to the user.

The arrow proxy 206 may be an HTTP proxy server. The arrow proxy 206 uses a rules-based approach to determine user session data that should be stored and read and determines how to bucket a user into a user segment. Because the arrow proxy 206 is implemented as an HTTP proxy it can sit outside the cache 208, which allows the arrow proxy 206 to collect user behavior data for pages that are served from the cache 208. If a user is bucketed in a given user segment, the bucket information is included in the cache key.

When the arrow proxy 206 receives an HTTP request, the arrow proxy 206 captures referrer data, reads previous session data, runs bucketing rules, proxy requests to the site application server and writes additional session data. For example, the arrow proxy 206 may capture referrer data by reading the HTTP “REFERER” header to determine whether the user request originated on a third party site. If so and if the site was a search engine, the hostname and search terms are bound to the user's session. The arrow proxy 206 may read previous session data by checking for any previously stored session data bound to the user (e.g., from the RTSS 228). It will be appreciated that although the RTSS 228 in FIG. 2 is used to store the user data, any key-based data store may be used to store the user data. If previous session data is found, it is bound to the user.

When the arrow proxy 206 runs bucketing rules, the arrow proxy 206 looks up the rules configured for this URI path. If any rules are found, the rules are run on the user (i.e., on the user data). The end condition of a successful rule set typically involves adding a user to a given user segment, or bucket. The arrow proxy 206 may proxy requests to the site application 212 by adding the bucket information to the HTTP request before proxying the request to the downstream site application 212. The site application 212 can then process the request as it normally would, with the user bucket data at its disposal. This allows the site application 212 to cater the content it serves based on the user bucket that a user belongs to.

The arrow proxy 206 is also used after the site application 212 handles the request. The arrow proxy 206 then runs another set of rules to determine what session data to persist in the session data store (RTSS in this case). It will be appreciated that in one embodiment the request to persist the additional data may be made asynchronously as the optimized page is being served to the end user, so as to not have a noticeable impact on page-load time. Exemplary data includes a page, URL, category, site, referring site, referrer search terms and the like.

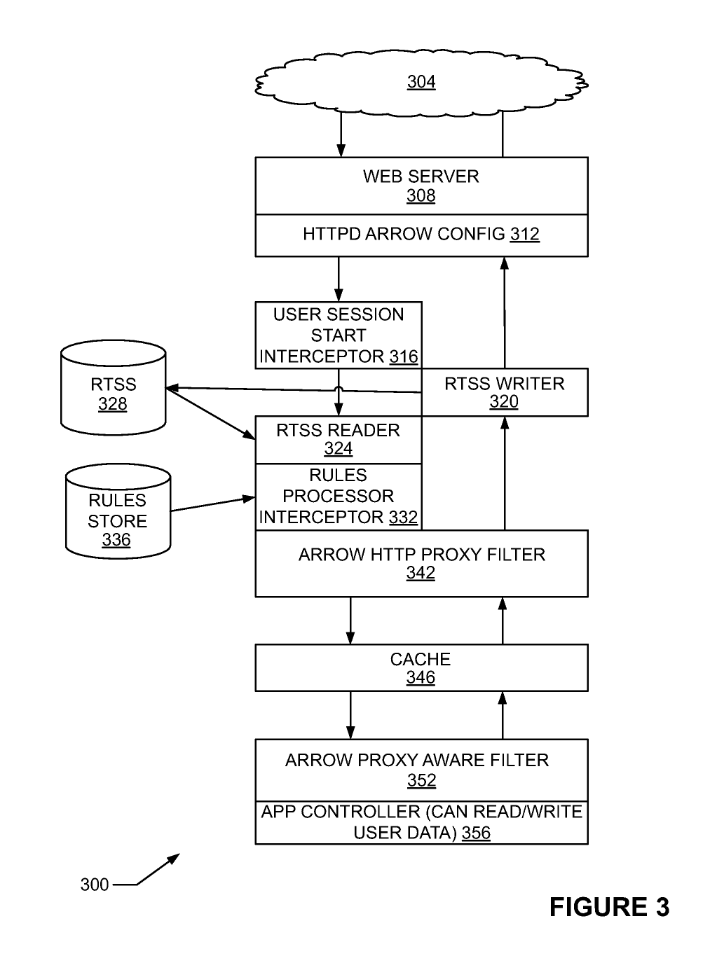

FIG. 3 illustrates a detailed view of an exemplary architecture 300 that includes the arrow proxy 206. As shown in FIG. 3, user requests 304 are received at the web server 308, which is communication with the HTTPD arrow config 312. The HTTPD arrow config 312 is in communication with the user session start interceptor 316. An RTSS writer 320 is also in communication with the HTTPD arrow config 312, and the user session start interceptor 316 is in communication with an RTSS reader 324. The RTSS reader 324 reads content from the RTSS 328 and the RTSS writer 320 writes content to the RTSS 328. The RTSS reader 324 is also in communication with the rules processor interceptor 332 which accesses rules in the rules store 336. The rules processor interceptor 332 is in communication with the arrow http proxy filter 342, which is in communication with the cache 346. The cache 346 is in communication with the arrow proxy aware filter 352 which is communication with the app controller 356. The arrow HTTP proxy filter 352 is also in communication with the RTSS writer 320.

As described above, the arrow proxy 206 is a webapp that sits outside the outermost HTTP page caching tiers to provide the arrow proxy functionality that occurs even when a cached page is returned. In addition to proxying the request to another server tier for handling, the arrow proxy serves three primary functions: reading user RTSS data to determine if the user belongs to one or more interest groups, and, if so, including this data as an HTTP request header for use by downstream handlers; writing bulk RTSS data to track the browsing activity of our users even when the user is served a cached page; and generating a temporary session id if no DW session id is found for RTSS use (if both are found, the arrow proxy 206 does an RTSS merge of the data to the DW session id). It will be appreciated that most of the functionality provided by the arrow proxy can be integrated directly into the page-generating webapp as described below.

Arrow provides a framework for webapp developers to easily set and retrieve user personalization data using RTSS. By including one or more of the Arrow interceptors or taglibs, webapp developers can read RTSS data for a given user, bulk-set RTSS user history data, or set and get specific RTSS data for a given use case.

HTTPD arrow config 312 (referrer header information) runs on the web server and writes referrer information into headers for use by the arrow proxy. The httpd-arrowconfig 312 parses the referrer header to extract the external referrer host and search string. This data is set as HTTP headers for downstream applications to consume and as environment values fields for consumption. In one embodiment, the values are only set if the referrer is from a search engine, such as google or yahoo. Exemplary variables include REFERER-HOST and REFERER-SEARCH-TERMS. Exemplary HTTP headers include X-REFERER-HOST and X-REFERER-SEARCH-TERMS.

The user session start interceptor 316 runs on the arrow proxy and looks for referrer information in the header and writes it to the user object. The user session start interceptor 316 initializes a few values for the arrow system to use. Mainly, the user session start interceptor 316 reacts to the headers set in the httpd-arrow-config config files. The user session start interceptor 316 looks for headers that communicate the following exemplary information via header: the referrer URL, the referrer domain and the referrer search term. If found, this information is stored in the user object and passed on to the next interceptor.

The RTSS reader interceptor 324 runs before the request is proxied downstream. The RTSS reader interceptor 324 reads information from the RTSS 328 that is pertinent to the user and stores it in the user object. The RTSS reader interceptor 324 runs before the request is proxied to the downstream server, and queries the RTSS 328 for any data stored for the current user. The RTSS reader interceptor 324 can be configured to run and get either all or some subset of the user data for each user it encounters. If the RTSS reader interceptor 324 comes across any user data, it stores that data into the user object for later modules to access. Examples of the types of data the RTSS reader interceptor 324 pulls include a user's browsing history, past search terms, user bucket information for multivariate testing, and the like.

The RTSS writer interceptor 320 runs after the request has completed, operates on the user object and stores unsaved data (asynchronously) from the user object to the RTSS 328 before returning the response. The RTSS writer interceptor 320 is an interceptor that runs after the request has completed. The RTSS writer interceptor 320 inspects the user object and looks for values that are marked as needing to be persisted in the RTSS 328 and then asynchronously sends queued RTSS requests to store that data. Examples of the types of data the RTSS reader interceptor 324 stores in the RTSS 328 a user's browsing history, past search terms, user bucket information for multivariate testing, and the like.

The rules processor interceptor 332 can be configured to operate on any object. The rules processor interceptor 332 is a simple rules processing engine that inspects and conditionally mutates an object passed to it. The rules processor interceptor 332 is configured with a collection of rules and conditions which both conform to a component interface and are stored in the rules store 336. In one embodiment, the component interface has an execute method which results in a positive or negative result. These components can be configured to have a positiveNextStep or a negativeNextStep each of which also conforms to the component interface. Since actions and conditions both conform to the same interface, the rules processor interceptor 332 can generically nest any combination of conditions and actions. The rules processor interceptor 332 is typically configured to operate on (and modify) the user object.

The Arrow HTTP proxy filter 342 runs before the request is proxied downstream and again after the response returns. Before proxying downstream, the Arrow HTTP proxy filter 342 serializes important information from the user object to headers for reading by the proxy aware filter 352. After receiving the response from the proxy aware filter 352, the Arrow HTTP proxy filter 342 de-serializes header information into the user object so that it may be detected and saved to the RTSS 328 by the RTSS writer 320.

The Arrow HTTP proxy filter 342 is run on the Arrow Proxy before passing the request on to the downstream server, and receives the response back from the downstream app. Before the Arrow HTTP proxy filter 342 passes the request downstream, the Arrow HTTP proxy filter 342 can inspect the user object to set certain HTTP headers into the request. Exemplary headers include the X-USER-RTSS-DATA and X-USER-BUCKET. For every RTSS name/value pair of data bound to the user, the X-USER-RTSS-DATA header is set, allowing downstream applications to access the user's RTSS data. The X-USER-BUCKET is a token that signifies the additional application state that is not represented in the URL, which can be used by the cache 346 to distinguish different HTML versions of the same page. The arrow proxy aware filter 352 may need to vary on the X-USER-BUCKET, which is set by the proxy filter 342. In particular, the arrow proxy aware filter 352 tells the cache 346 to vary on it when it responds. After proxying to the downstream app(s), when the Arrow HTTP proxy filter 342 receives a response from downstream, it looks in the response for headers of a specific format. Any headers that match this format are de-serialized and set into the user object, and are persisted in the RTSS 328 by the RTSS writer 320.

The RTSS writer 320 writes common request data to the RTSS 328 for, each pageview and can be configured to run for a given set of page types. The RTSS writer 320 may be used to write to the RTSS 328 on an every request basis. For example, a log of a users browsing history may be used by the RTSS writer 320.

The Arrow HTTP proxy aware filter 352 de-serializes header information and stores it in the user object when a request is received and serializes data that has been written into the user object into headers for the arrow proxy to persist in the RTSS 328. The Arrow HTTP proxy aware filter 352 is one of the first components to run on an appserver downstream from the arrow proxy, and is also one of the last components to run on the downstream application server before returning the request to the arrow proxy. Before the application processes the request, when the Arrow HTTP proxy aware filter 352 receives a request from the upstream server, the Arrow HTTP proxy aware filter 352 first looks for arrow headers coming from the upstream app, and ingests their data into a user object that can be conveniently used by the controller 356 or JSPs that rely on those headers for their features to work After the request is processed, the Arrow HTTP proxy aware filter 352 inspects the user object in its request and looks for variables that have been set into the user object and serializes them into response headers that the Arrow HTTP proxy aware filter 352 knows how to read and knows are meant to be stored in the RTSS 328. An exemplary header that can be used to store this information is X-RTSSPERSIST. The X-RTSS-PERSIST header can contain any number of name value pairs that correlate to values that can be set on the user object. When these are set on the response by the Arrow HTTP proxy aware filter 352, these values will be stored in the RTSS 328.

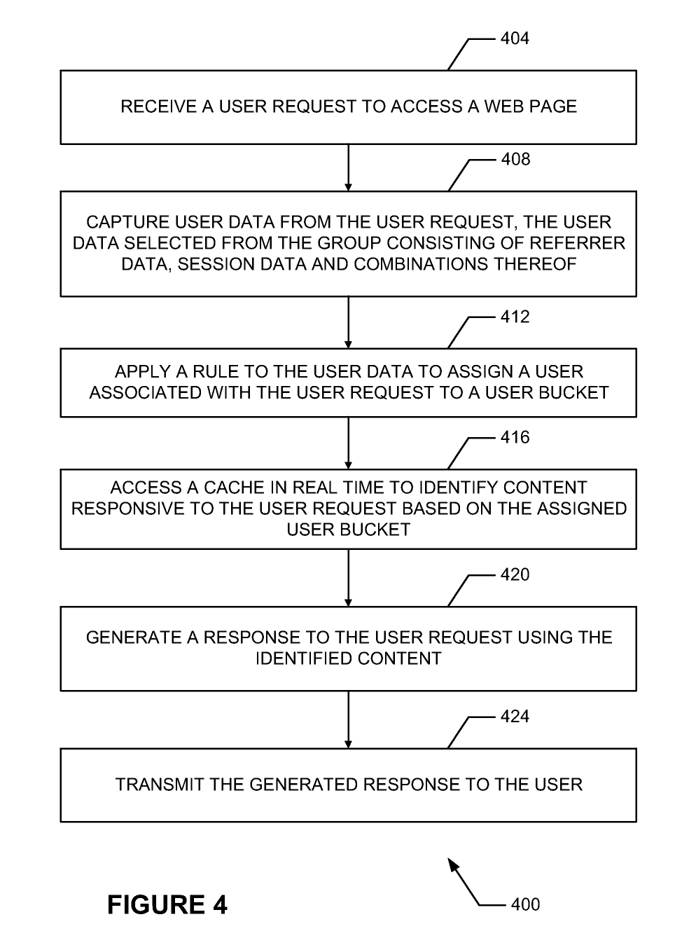

FIG. 4 illustrates a process for collecting data that can be used to target web pages based on the page request 400. It will be appreciated that the process 400 described below is merely exemplary and may include a fewer or greater number of steps, and that the order of at least some of the steps may vary from that described below.

The process 400 begins by receiving a user request to access a web page (block 404). For example, a user may request to access a download.com page.

The process 400 continues by capturing user data from the user request, the user data selected from the group consisting of referrer data, session data and combinations thereof (block 408). Types of data about the user include page, URL, category, site, referrer site and referrer terms.

The process 400 continues by applying a rule to the user data to assign a user associated with the user request to a user bucket (block 412). It will be appreciated that a user may be assigned to multiple user buckets. It will also be appreciated that more than on rule (i.e., a set of rules) may be applied to the user data to assign the user to the one or more user buckets. The rule may apply a flag or threshold value that indicates that a user is a member of the user segment or bucket.

The process 400 continues by accessing a cache in real time to identify content responsive to the user request based on the assigned user bucket (block 416). It will be appreciated that the content used to generate a response for the user may be accessed directly from the cache; alternatively, the content may be accessed indirectly from the cache (i.e., from the cache and through the site application, data API and/or data stores).

The process 400 continues by generating a response to the user request using the identified content (block 420). The response includes targeted content based on the user's user bucket. For example, the web page may include several page components and one or more of the page components may include content selected based on the user's assigned user bucket. The process 400 continues by transmitting the generated response to the user (block 424).

For example, a user may perform a Google search for McAfee antivirus software. The user may then select a search result that refers the user to the download.com website which provides users with the ability to download antivirus software. The user will then be bucketed into a group associated with downloading antivirus software. The user may be returned a web page that includes advertisements that relate to antivirus software that competes with McAfee antivirus software. If a user were to download antivirus software, the user would then be bucketed into a group that has already downloaded antivirus software. The user could then be targeted with different advertisements related to the website (e.g., an advertisement for tv.com, another website owned by CBS Interactive, or an advertisement for a television show on CBS).

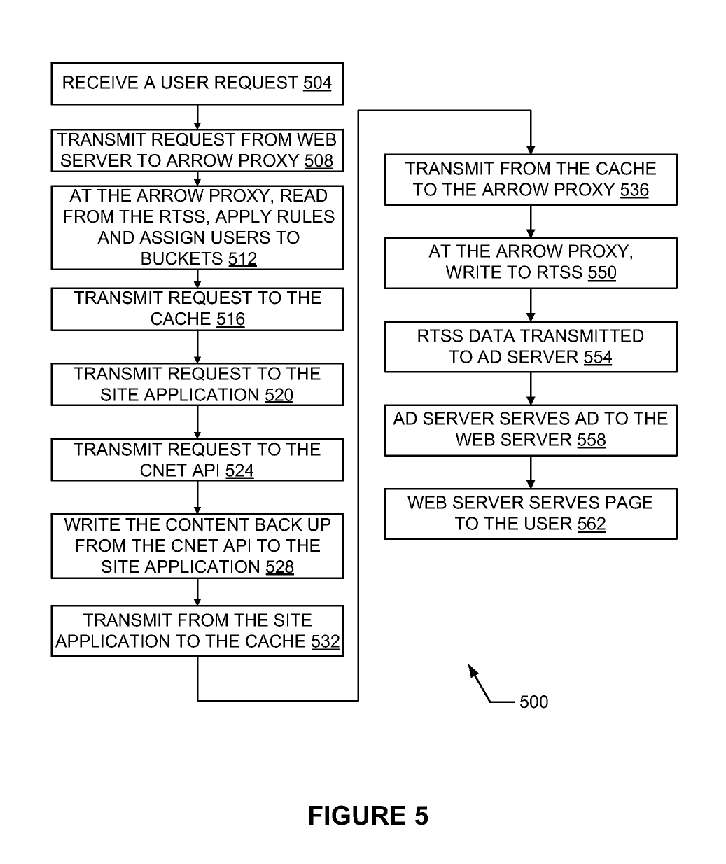

FIG. 5 illustrates a detailed process 500 for delivering a page in response to a page request using the architecture stack illustrated in FIG. 2. It will be appreciated that the process 500 described below is merely exemplary and may include a fewer or greater number of steps, and that the order of at least some of the steps may vary from that described below.

As shown in FIG. 5, the process 500 begins by receiving a user request (block 504). The process 500 continues by transmitting the request from the web server to the arrow proxy (block 508). The process 500 continues by, at the arrow proxy, reading from the RTSS, applying rules and assigning users to buckets (block 512).

The process 500 continues by transmitting the request to the cache (block 516), transmitting the request to the site application (block 520), and transmitting the request to the data API (block 524).

The process 500 continues by writing the content back up from the data API to the site application (block 528), transmitting the content from the site application to the cache (block 532), and transmitting the content from the cache to the arrow proxy (block 536).

The process 500 continues by, at the arrow proxy, writing to the RTSS (block 550). The process 500 continues by transmitting RTSS data to the ad server (block 554). The process 500 continues by the ad server serving an ad to the web server (block 558). The process 500 continues by the web server serving a page to the user (block 562).

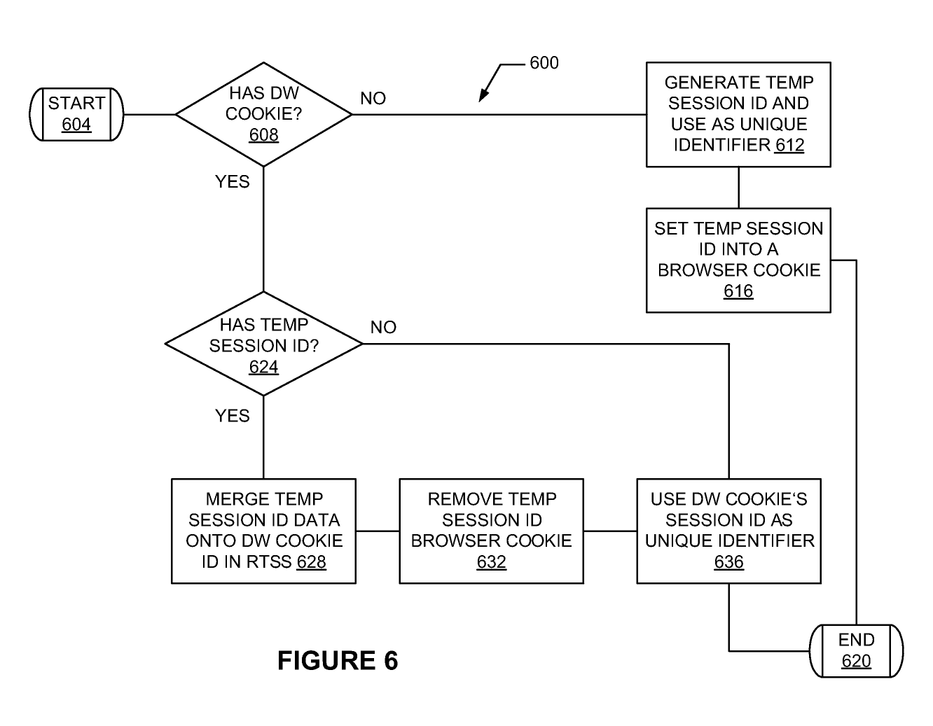

FIG. 6 illustrates an exemplary process 600 for assigning a user an identifier. It will be appreciated that the process 600 described below is merely exemplary and may include a fewer or greater number of steps, and that the order of at least some of the steps may vary from that described below.

As shown in FIG. 6, the process 600 starts 604 by determining whether the user has a DW cookie (block 608). If no, the process 600 continues by generating a temporary session id to which any information of interest may be attached (block 612). The process 600 continues by setting the temporary session id into a browser cookie (block 616) and the process ends 620. This value will be available again on their next request (i.e., using the DW cookie).

At block 608, if yes, the process continues by determining whether the user has a temporary session id (block 624). If yes, the process 600 continues by merging the temp session id data onto the DW cookie id in RTSS (block 628), removing the temp session id browser cookie (block 632) and using the DW cookie's session id as the unique identifier (block 636) before ending 620. After the first user visit, the DW cookie id can be used as the users' unique identifier. In order to keep the information gathered on their first hit, the data from the temp session id is merged with the DW cookie data and associated with the DW cookie id in RTSS. The record linked to the temporary session id is then deleted. This is commonly referred to as an RTSS merge. If no, the process continues to block 636 before ending 620.

It will be appreciated that, in the above process 600, the DW session id may be set by an external system and is accessible by the arrow proxy 206 upon the user's second page view. The arrow proxy 206 sets/removes the temp session id as needed but may not set the DW cookie id.

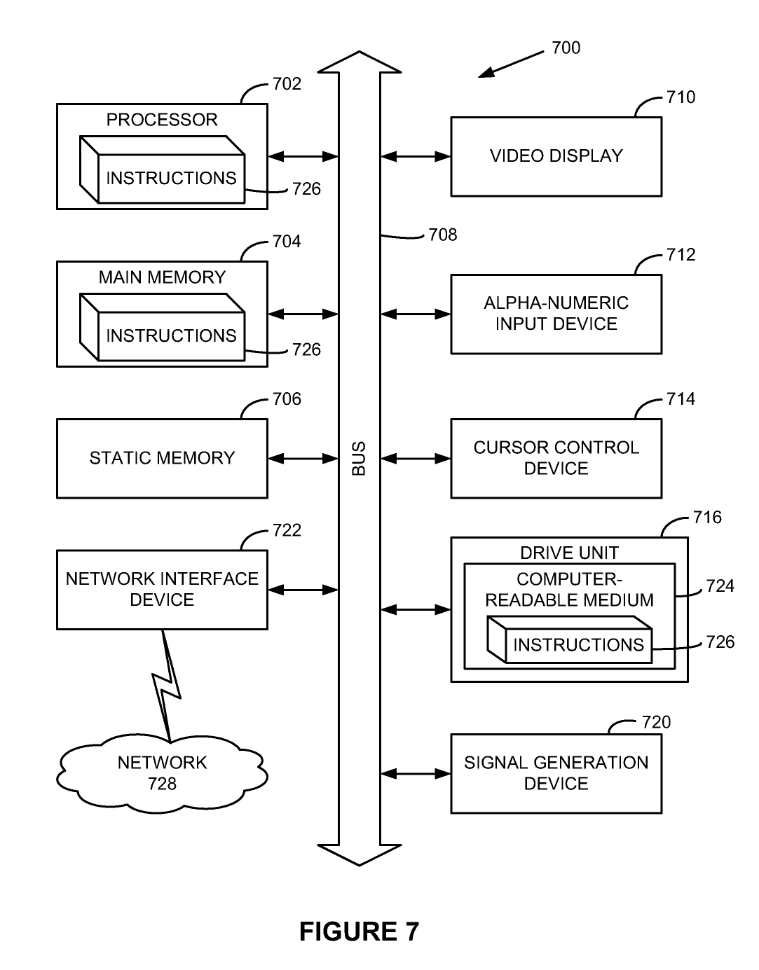

FIG. 7 shows a diagrammatic representation of machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU), a graphics processing unit (GPU) or both), a main memory 704 (e.g., read only memory (ROM), flash memory, dynamic random access memory (DRAM) such as synchronous DRAM (SDRAM) or Rambus DRAM (RDRAM), etc.) and a static memory 706 (e.g., flash memory, static random access memory (SRAM), etc.), which communicate with each other via a bus 708.

The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 720 (e.g., a speaker) and a network interface device 722.

The disk drive unit 716 includes a computer-readable medium 724 on which is stored one or more sets of instructions (e.g., software 726) embodying any one or more of the methodologies or functions described herein. The software 726 may also reside, completely or at least partially, within the main memory 704 and/or within the processor 702 during execution thereof by the computer system 700, the main memory 704 and the processor 702 also constituting computer-readable media. The software 726 may further be transmitted or received over a network 728 via the network interface device 722.

While the computer-readable medium 724 is shown in an exemplary embodiment to be a single medium, the term “computer-readable medium” should be taken to include a single medium or multiple media (e.g., a centralized or distributed database, and/or associated caches and servers), non-transitory, that store the one or more sets of instructions. The term “computer-readable medium” shall also be taken to include any non-transitory medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

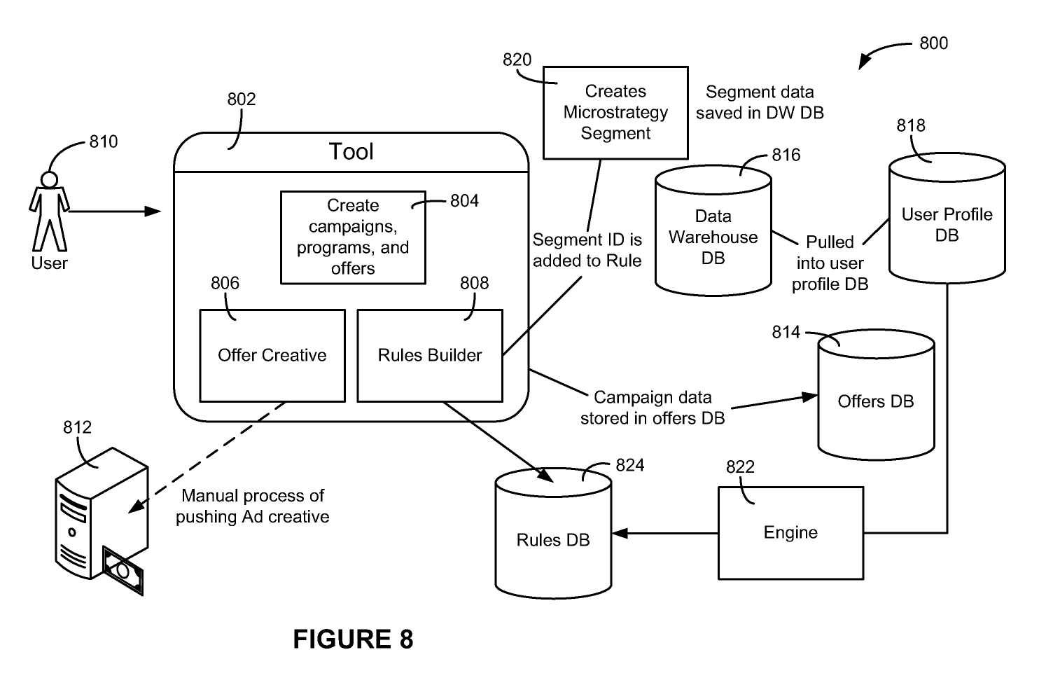

Referring now to FIG. 8, a schematic diagram of an exemplary computer system or tool for creating a rule-based marketing offer for a web site will be described. A web site is a collection of related web pages, images, videos or other digital assets that are addressed relative to a common Uniform Resource Locator (URL). A web site is hosted on at least one web server, accessible via a network such as the Internet or a private local area network. A web page is a document, typically written in plain text interspersed with formatting instructions of Hypertext Markup Language (HTML, XHTML). A web page may incorporate elements from other websites with suitable markup anchors. The computer system may provide personalization, profiling and/or targeting of offers. System 800 may comprise a tool that creates and serves dynamic, relevant offers to segments of a web site's audience to increase product conversion, engagement and/or revenue. System 800 may be configured to generate a marketing offer that reacts in real time to interactions with the web site by a user. System 800 may be scalable across a plurality of web sites for use by different business units of an organization (e.g., cnet.com, bnet.com, cbssports.com, etc.). The offers may comprise surveys, intercepts, overlays, advertisements, subscription products (e.g., newsletters, alerts, fantasy leagues, etc.), site-related products, registrations, RSS feeds, alerts, contests, etc. System 800 may be configured to display relevant, contextual offers as overlays or in other formats. System 800 may be configured to display more appealing survey offers to users.

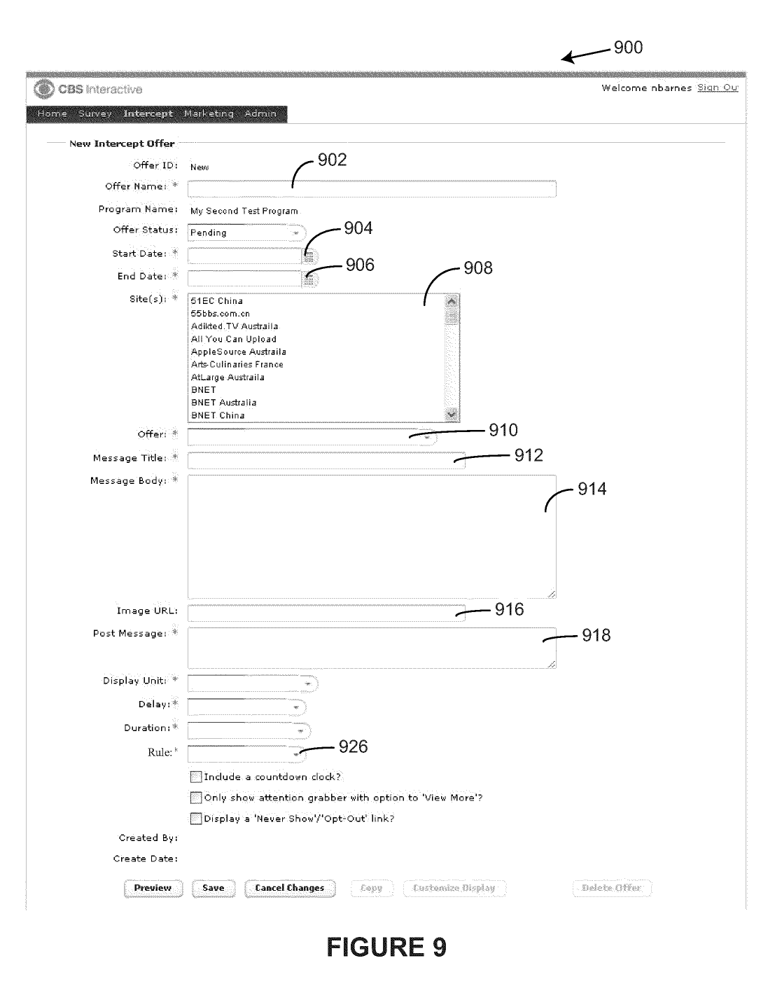

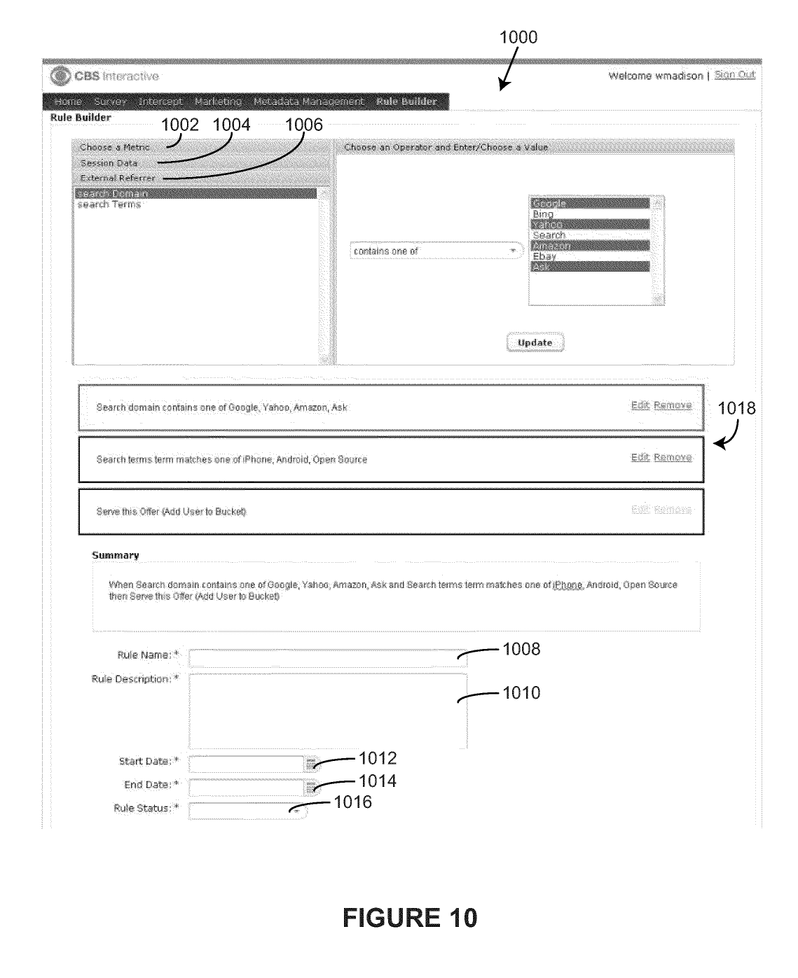

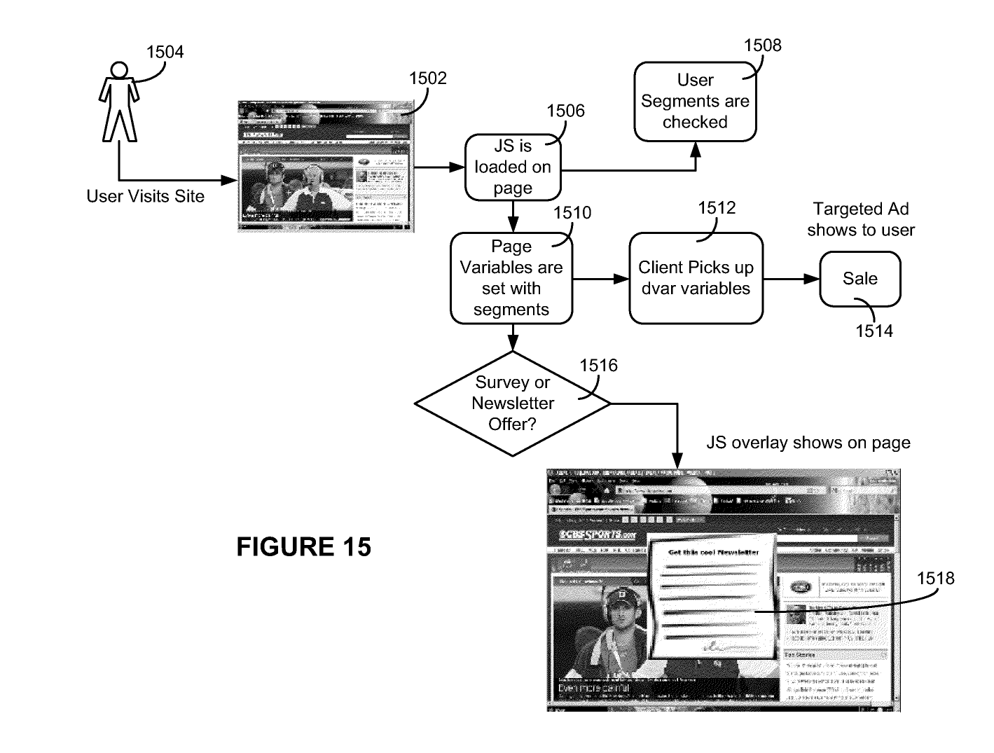

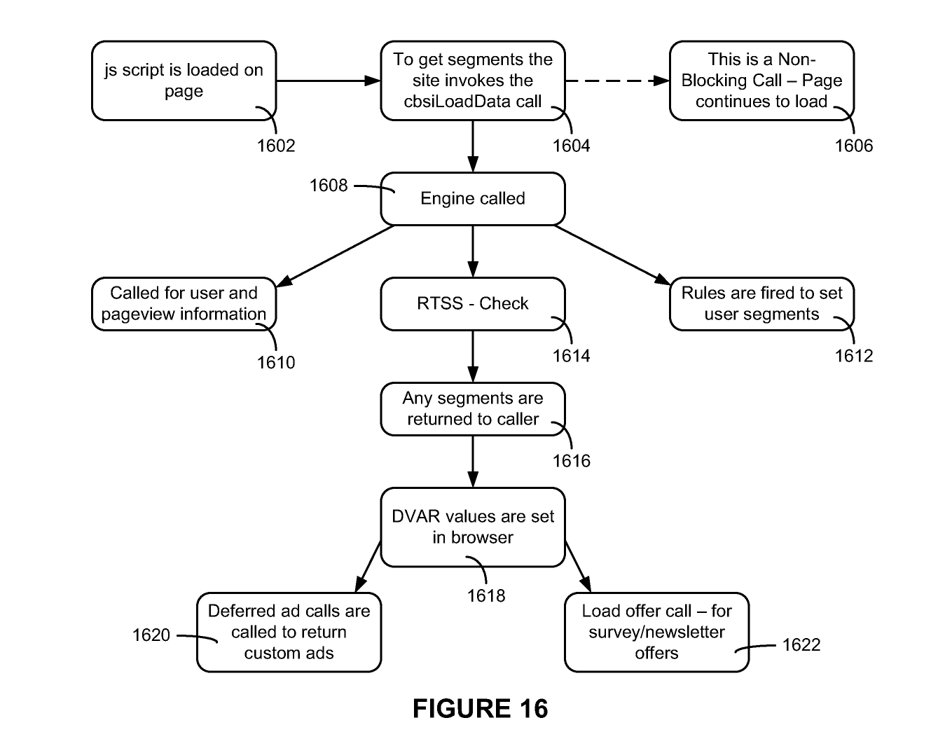

Tool 802 comprises a plurality of modules, including a marketing offer creation module 804, an offer creative module 806, and a rules builder module 808. Offer creation module 804 is configured to provide a web page comprising a plurality of fields to a user (e.g., in this case a person or persons tasked with creating a marketing offer for use on a web site), and to receive parameters from user 810 for the creation of a marketing campaign, program or other offer (see, e.g., FIGS. 9, 13 and 19). Offer creative module 806 is a module configured to receive creative elements of the offer (e.g., graphics, text, colors, images, videos, etc.) from user 810 and to push or transmit an offer creative data file to an advertising server 812 for use by web pages of a web site. Rules builder module 808 is configured to receive rules defined by user 810 indicating the criteria for pushing an offer to a web page, such as a user's attributes (see, e.g., FIG. 10). Tool 802 is configured to use modules 804, 806 and 808 to output campaign data to an offers database 814. Offers database 814 is configured to store the rule-based offers generated by tool 802 for use by a web server (such as those described with reference to FIGS. 2-5) to generate web pages viewable by users from client computers (see, e.g., FIGS. 15 and 16). The rules created by rules builder 808 may be stored in a rules database 824.

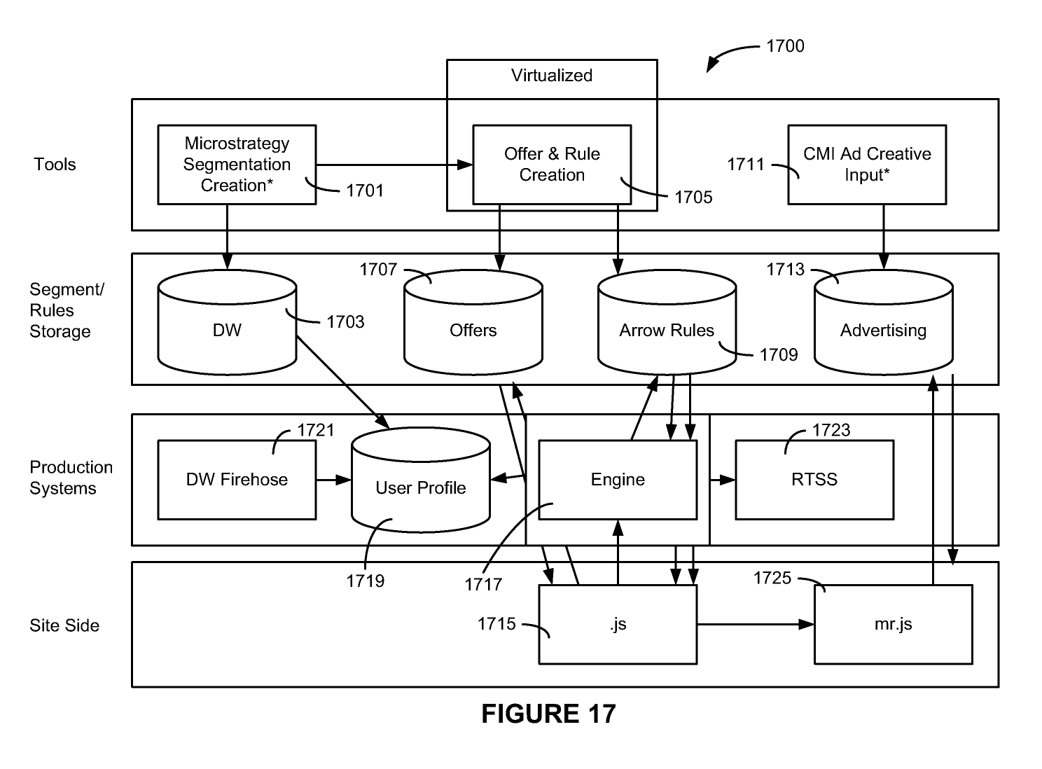

Tool 802 is configured to access any of a plurality of databases in the process of creating the offers. A data warehouse (DW) database 816 is configured to store user attributes for client-side users of the web site, such as data relating to user interactions with web pages, user registration information representing data received about the user during a registration process (e.g., demographics, geographic location entered by a user in a registration form, products purchased, etc.), subscriptions a user has, IP lookup data which can include user location, user preferences and favorites, session data representing user interaction with a web site during a session (e.g., page type, ontology ID, etc.), external site referral data representing a site other than the web site which referred the user to the web site (e.g., search engine domain, search terms or keywords), site-specific data (e.g., purchase history at a particular web site, subscription data, etc.), social media sites or information therefrom, open form keywords, favorite sports team(s), favorite sports, or other user characteristics or attributes. (see, e.g., FIG. 17). Demographic data may comprise such characteristics as gender, race, age, income, disabilities, educational attainment, home ownership, employment status, location of work or home, etc.

Session data may comprise a series of events performed by a single user that can be tracked, possibly across successive web sites separated by no more than 30 minutes of inactivity. Sessions may be identified by measuring a time interval between consecutive activities; that is, if the duration between two events in a session exceeds a predetermined time period, (e.g., 30-minutes), a new session is created. A session may be a sequence of one or more data warehouse-tracked page views and/or redirect tracked events for a single user, separated by no more than a predetermined time period (e.g., 30 minutes) of inactivity. The user may be identified through either a data warehouse cookie or ip/user-agent combination.

Exemplary user attribute data are shown in the chart below:

| GROUP_NAME | NAME | DESCRIPTION |
|---|---|---|
| External Referrer | search domain | The value of the external referrer domain from which the internet user came from to the |
| | | CBSi site. |
| External Referrer | search terms | The value of the external referrer search terms from which the internet user used in |
| | | searching. |
| Session Data | asset id | The assest id of the page the internet user is viewing. |
| Session Data | node id | The node id of the page the internet user is viewing. |
| Session Data | operating system | The operating system the internet user is using in viewing a CBSi site. |
| Session Data | page type id | The page type id the internet user is viewing. |
| User Registration - Outbound | email domain | The value of the domain of the CBSi user email address. |
| User Registration - Outbound | email list id | The value of the email/newsletter list id, usually referred too as an eCode. |
| User Registration - Outbound | email type | The type of email the CBSi user receives, usually HTML or Text |
| User Registration - Outbound | last click | The most recent time that a CBSi user clicked a link in a CBSi delivered email. |
| User Registration - Outbound | last open | The most recent time that a CBSi user opened a CBSi delivered email in their inbox. |
| User Registration - UREG | DMA code | The DMA code (3 digit numerical value) of the UREG registered CBSi user. |
| User Registration - UREG | DMA name | The DMA name of the UREG registered CBSi user. |
| User Registration - UREG | birth year | The birth year only (yyyy) of the UREG registered CBSi user. |
| User Registration - UREG | campaign segment id | The city of the UREG registered CBSi user. |
| User Registration - UREG | city | The city of the UREG registered CBSi user. |
| User Registration - UREG | country | The country (3 character code like ‘USA’) of the UREG registered CBSi user. |
| User Registration - UREG | email domain | The domain of the UREG registered CBSi user email address. |
| User Registration - UREG | gender | The gender of the UREG registered CBSi user. |
| User Registration - UREG | occupation | The occupation name of the UREG registered CBSi user. |
| User Registration - UREG | region | The state of the UREG registered CBSi user. |
| User Registration - UREG | registration date | The date that this user registered in the UREG system. |
| User Registration - UREG | state | The state of the UREG registered CBSi user. |
| User Registration - UREG | zip code | The zip code of the UREG registered CBSi user. |
| User Registration - URS | DMA code | The DMA code (3 digit numerical value) of the URS registered CBSi user. |
| User Registration - URS | DMA name | The DMA name of the URS registered CBSi user. |
| User Registration - URS | birth year | The birth year only (yyyy) of the URS registered CBSi user. |
| User Registration - URS | city | The city of the URS registered CBSi user. |
| User Registration - URS | company size | The company size of the URS registered CBSi user. |
| User Registration - URS | country | The country (2 character code like ‘US’) of the URS registered CBSi user. |
| User Registration - URS | email domain | The domain of the URS registered CBSi user email address. |
| User Registration - URS | gender | The gender of the URS registered CBSi user. |
| User Registration - URS | industry | The industry of the URS registered CBSi user. |
| User Registration - URS | job function | The job function of the URS registered CBSi user. |
| User Registration - URS | registration date | The date that this user registered in the URS system. |
| User Registration - URS | state | The state of the URS registered CBSi user. |
| User Registration - URS | zip code | The zip code of the URS registered CBSi user. |

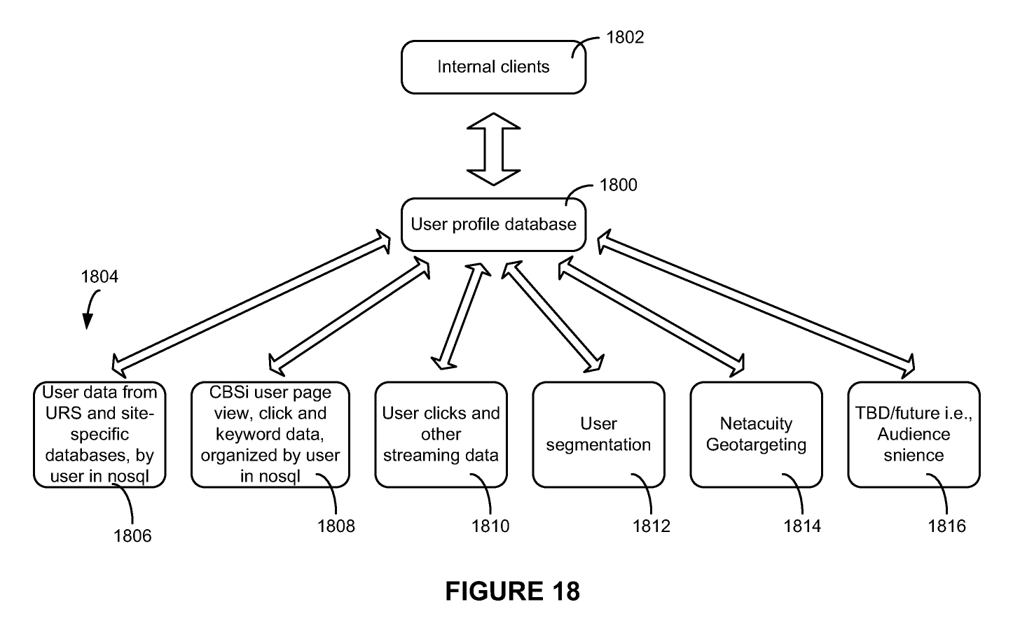

A user profile database 818 can be configured to provide rich user profiles based on data from DW database 816 and/or other sources, the user profiles simplifying use by other tools such as tool 802. (See, e.g., FIGS. 18-23). User profile database 818 may comprise a subset of data about a user, but in a more useable format than that stored in data warehouse 816. User profile database 818 may comprise demographic data, an indication of any current and/or past newsletter subscriptions, site traffic information, keyword information, etc.

A segmentation module 820 is configured to segment users into buckets or other categories based on their attributes, each segment having an associated segment ID which can be added to and used by rules generated by rules builder module 808. Segmentation module 820 may comprise an analysis and reporting module configured to analyze data stored in data warehouse 816. In one exemplary embodiment, Microstrategy business intelligence software may be used, which is sold by Microstrategy, Inc., McLean, Va. Segmentation module 820 allows users to run queries, such as demographically-based queries, for example to report a list of all users who purchased product A last year, but not this year and greater than company size 100 (e.g., a defined market segment). The segments or other output data may be pulled into and stored in user profile database 818. Segment IDs can also be stored in user profile database 818.

Segmentation module 820 is configured to run queries against the data warehouse database 816. When a query is created that one wishes to target against, then it is saved and scheduled to run and export on a daily basis. That data is exported to database 818 and that segment is saved as part of a user's “profile” and then rules in the system can be made to target against that data.

Engine 822 comprises a web service which makes calls to user profile database 818 and runs the information from user profile database 818 through rules stored in rules database 824 to determine whether any of the rules are met by a user. Engine 822 may comprise a rules engine for processing of rules based on attributes and delivery of offers.

Referring now to FIG. 9, a web page 900 for use in an offer creation process will be described. Offer creation module 804 (FIG. 8) may be configured to generate and provide web page 900 to user 810, to receive from a user such things as a type of overlay, size, location, static or moving overlay, direction of movement of overlay, whether overlay is a pop-up overlay (e.g., which can be minimized and maximized to show different amounts of data), and other configurations. In this embodiment, web page 900 is used to collect parameters for an intercept. An intercept may comprise a file or module configured to take over a user session by showing an overlay and providing information and receiving an interaction from a user. In one example, user interaction with some or all of a web page is disabled, and/or some or all of a web page is changed in brightness, color, or other appearance, while the intercept displays an overlay with text, graphics and/or user input portions configured to receive user interactions and transmit the interaction data back to a server. In one embodiment, an intercept may be used for marketing offers relating to the web site being used and not to offers from third party businesses. Offers may comprise an intercept, a newsletter offer, an offer for a sports-related product, a survey, an advertisement, or other offer, which can include anything presented to the user that the user may want, not necessarily because of the page they are on, but also perhaps based on the user profile, history, belonging to a segment, etc. A market segment may be a subset of a market made up of people or organizations with one or more characteristics that cause them to demand similar product and/or services based on qualities of those products such as price or function.

Intercept creation web page 900 is configured to receive an offer name at an offer name field 902, start and end dates at start/end date field 904, 906 and a selection of which web site or web sites the intercept is to be used at a site field 908. The web sites may be associated with different businesses or business units.

According to one advantageous aspect, the computer system described herein may be configured to operate across and access user data from different web sites operated by different business units. Each web site may operate on separate networks, allowing different username/passwords for users, in which user data may be stored in different silos. However, the computer system described herein may be configured to access user attributes from a plurality of the different web sites on different networks in order to improve targeting of offers to users.

Offer field 910 is configured to receive an identifier in the database for an offer creative. Message title field 912 is configured to receive a textual title for a message to be displayed as part of the overlay and message body field 914 is configured to receive a corresponding body of the message. An image URL field 916 is configured to receive a URL for an image to be displayed as part of the overlay. A post message field 918 is configured to receive a message the user gets after accepting the intercept offer which is shown (e.g., a “thank you” message). The display unit field may indicate how the offer is shown on the page. The delay field may indicate how long to wait after a page load to show the offer. The duration field may indicate how long to show a unit if there is not a click on the unit. A rule field 926 is configured to receive an identifier of a rule to be run to determine whether, when and/or where (i.e. on which web site) the intercept is to be run. The rule identifier may be a rule name or other identifier. (See, e.g., FIG. 10).

In operation, web page 900 is configured to receive parameters for the offer from user 810, such as the necessary creative elements (E.g., messages, image, etc.). Rules and segments are defined by user 810 using field 926 and the web pages of FIG. 10 (described below). The overlay associated with the intercept may be selected and customized if necessary. Tool 802 is configured to generate the intercept based on this data. According to one embodiment, a javascript code (e.g., survey.js) or other file or code is then added to targeted locations of one or more web pages on one or more web sites, the code comprising a function call to Engine 822. The overlay then appears to users that are in the segment that was defined in the rule for the offer (e.g., see FIGS. 15 and 16). For example, the rule may state that any time a user does X and Y interactions with the web page, web site or a related web site (e.g., from other business units), and the user is currently on web site Z (e.g., www.gamespot.com), an intercept is pushed to the web page the user is currently on. In one embodiment, javascript code (e.g., ______.js) is present on each web page, the code being run to determine in real time the content of the web page and whether any overlay or other intercept is to be displayed.

Referring now to FIG. 10, a web page 1000 for use in a rule creation process will be described. Web page 1000 comprises a plurality of tabbed fields, such as a metric field 1002, a session data field 1004, an external referrer field 1006 and optionally other fields. User 810 selects a site or sites that the rule will be used for (see, e.g., field 908 in FIG. 9). Web page 1000 is configured to receive one or more metrics, operators and/or values (which may be based on the site selected), using field 1002. Rule name field 1008, rule description field 1010, start date/end date field 1012/1014 and rule status fields 1016 are provided to receive additional data from user 810. Rule status may be enabled, disabled, etc. After creation, the rule name is added to the list of rules that can be selected from a drop-down box on the offer creation page (field 926 in FIG. 9).

As one example, a search domain operator can be added to the rule to determine whether the search domain from a referring site (one that refers a client user to one of the sites available in site list 908) contains or is equal to a selected site (e.g., Google, Bing, Yahoo, etc.). As another example, a search term operator can be added to the rule to determine whether the search term(s) that referred the client user from the referring site contains one or more values. The operators associated with the rule being created may be displayed in operator display field 1018 so that the user 810 can see the operators and values that have been created and are currently associated with the new rule.

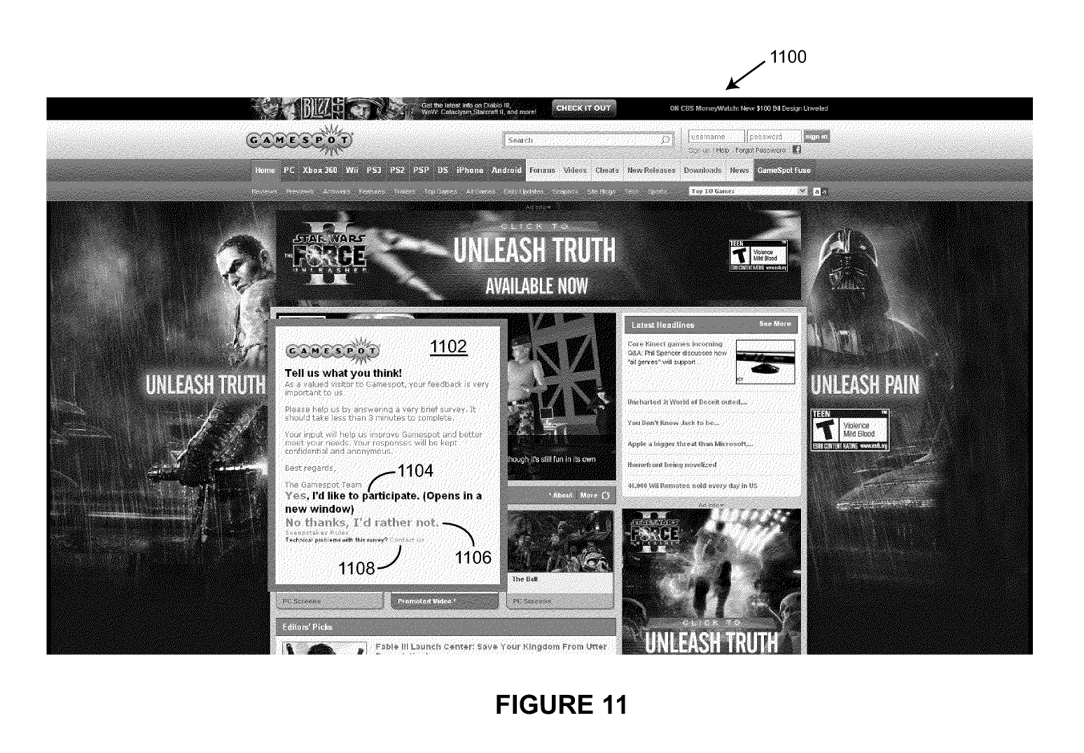

Referring now to FIG. 11, a web page 1100 is shown for www.gamespot.com, showing an exemplary offer output in the form of an overlay 1102. Overlay 1102 comprises a plurality of user input portions 1104, 1106 in the form of hyperlinks in this exemplary embodiment, configured to receive user interactions with overlay 1102 and return user interaction data to a server, such as that shown in FIG. 2 or 3. Overlay 1102 appears to at least partially overlay other portions of web page 1100.

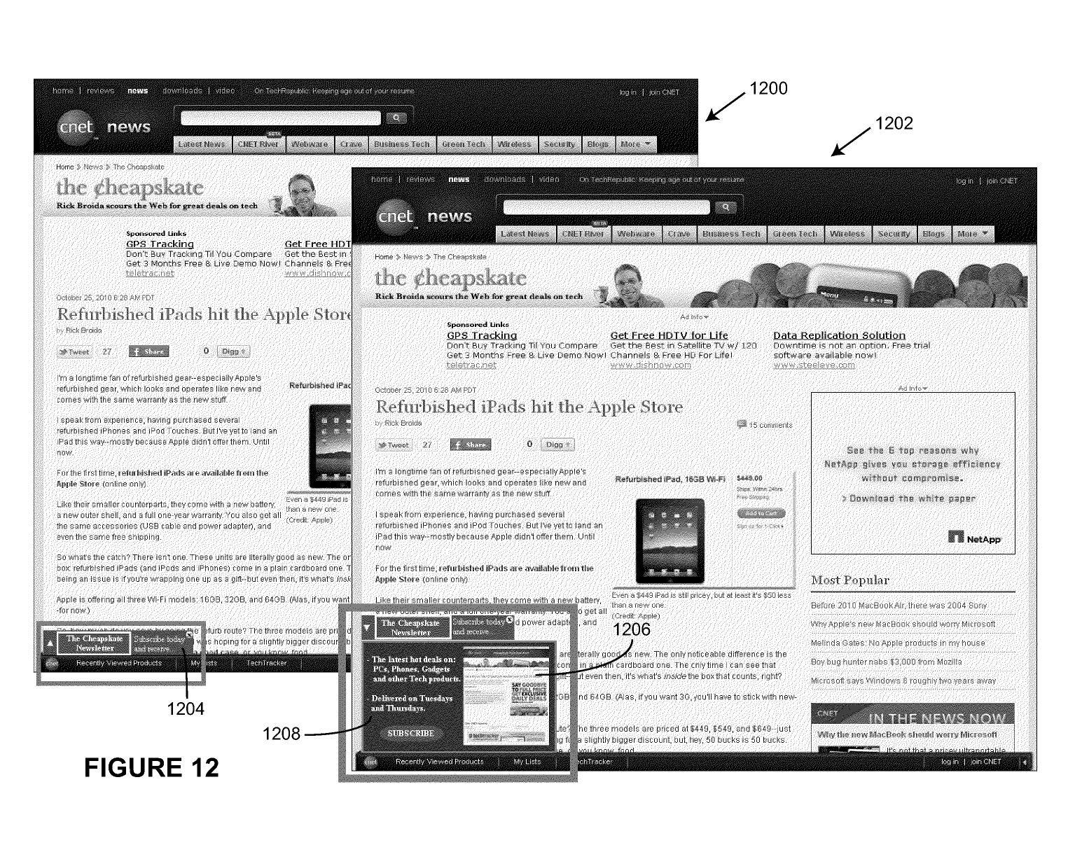

Referring now to FIG. 12, web pages 1200 and 1202 illustrate an intercept offer output. The intercept offer output is shown as an overlay 1204 on web page 1200 disposed in a lower left corner of page 1200. In this example, the intercept offer comprises an offer for a subscription to a newsletter. In response to user selection of an input portion, a web server may provide a web page configured to receive user input used to sign up the user for the newsletter. In response to user selection at a different portion of overlay 1204, overlay 1204 may be configured to expand as shown in web page 1202 to provide additional information about the offer, including in this case an image 1206 and additional textual information 1208.

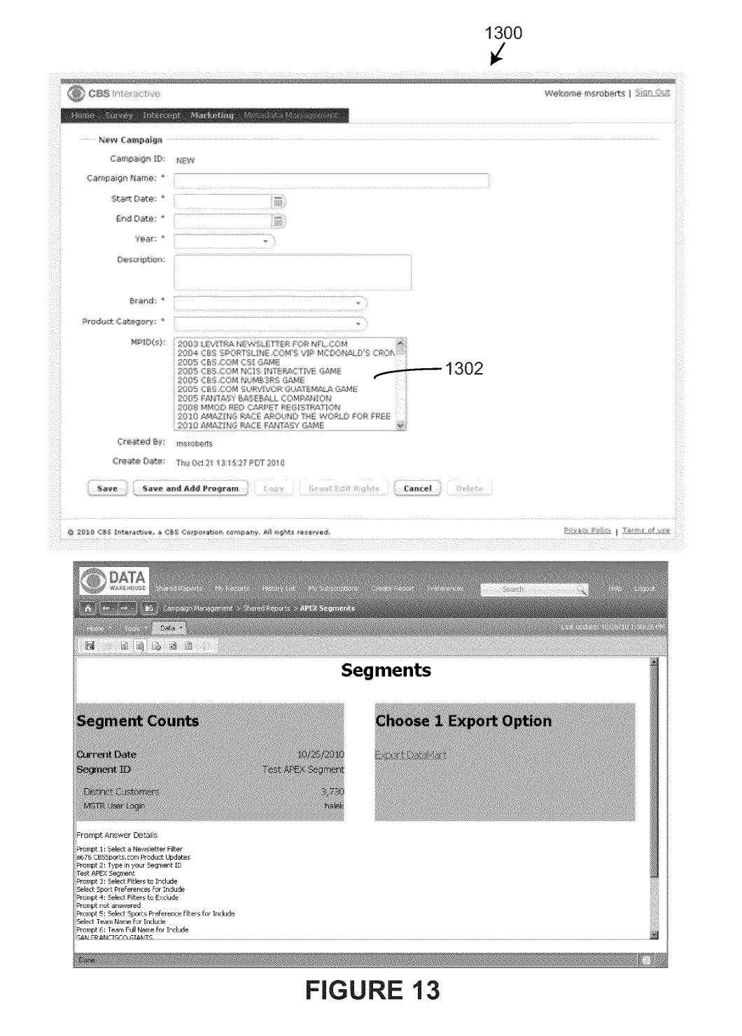

Referring now to FIG. 13, a web page 1300 for use in a marketing offer creation process will be described. Web page 1300 may be similar to web page 900 used for an intercept offer creation process. In web page 1300, a marketing program ID associated with a previously-created marketing program may be selected in MPID field 1302. For example, previously-created newsletters, game offers, and other marketing program offers may be selected. In other ways, web page 1300 is similar to web page 900, in that a name field 1304 is configured to receive a name, start/end date fields are provided, etc. A brand field can be used to group by business unit and a product category is a grouping within the brand.

A user may use page 1300 to define a campaign and program attributes. Web page 1300 may be configured to receive a definition of offer attributes and details and a segment ID from segment database 820 (which may comprise subscription data, purchase data, and other data which may not be stored in the data warehouse database 816) and associate these details with the offer. Tool 802 may then be configured to deploy the offer. The offer may be deployed by setting segmentation variables (DVARS) in the advertisement server 812 for any creative stored in advertisement server 812. For marketing offers, the copy-creative that is to be seen by the user is entered into ad engine or ad database 812 and a pointer to the DVAR bucket or segment is also entered into ad database 812 so that the DVAR can be used to retrieve the correct ad from the ad database 812.

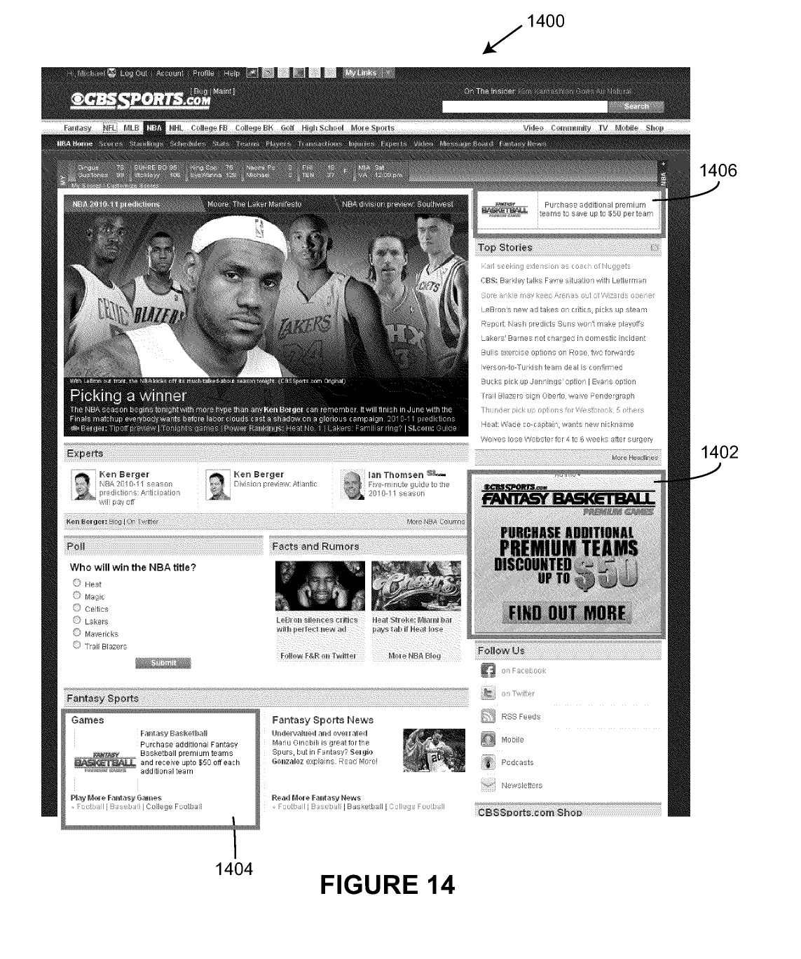

Referring now to FIG. 14, a web page 1400 illustrates a marketing offer output. The web page 1400 is associated with the web site www.cbssports.com in this exemplary embodiment. Marketing messages 1402, 1404 and 1406 are not in the form of intercepts in this exemplary embodiment, and provide marketing messages or offers which are synched with or customized based on attributes of the user viewing the site. For example, marketing message 1404 includes text inviting the user to “Purchase additional Fantasy Basketball premium teams” because the system knows from previously stored user attributes (e.g., stored in database 820) that the user has already purchased at least one Fantasy Basketball premium team.

Referring now to FIG. 15, a flow diagram illustrates a process of targeting offers to users of a web site. A computer system such as that shown in FIG. 1, 2, 3 or 7 is configured to process the steps shown in FIG. 15. A memory, such as memory 120, is configured to store a plurality of user attributes for a user, for example in user profile database 818 (FIG. 8). A memory, such as rules database 824 or offers database 814, may further be configured to store a plurality of rules defining conditions under which an offer is to be presented to a user. A module or processing circuit is configured to transmit a web page 1502 to a client device 1504 that is viewable by a client user. At a block 1506, a module is loaded on the web page displayed on client device 1504 which is configured to determine at block 1508 whether the user is in any predetermined marketing segments. Web page 1502 comprises page variables or variable data portions which may be populated with offers. At block 1510, if the user belongs to any segment, the variable data portions of the web page are associated with the offer data. At block 1512, a javascript client (mr.js) is configured to retrieve an advertisement from advertisement database 812 based on the market segment the user belongs to and at block 1514, an advertisement targeted to a user is displayed in the variable data portion of web page 1502. A dvar is a string, or variable, that matches a user segment to an ad.______.js fires and calls engine 822 to see if a rule fires and puts a person in a bucket. If so, a dvar is set with the value of the bucket. At block 1612, mr.js then sees those dvar values and checks to see if there is an ad setup for that site/position with that dvar value. If so, then the ad is shown. At block 1516, a rule from offers database 814 is run to determine whether an offer is to be presented to the user. If a rule is met, an offer is presented, for example in the form of overlay 1518.

According to one advantageous embodiment, each time a user interacts with or web page 1502 or otherwise changes an aspect of one or more user attributes stored in user profile database 818, the computer system is configured to determine whether an updated user attribute satisfies any rule from rules database 824 or offers database 814. If the updated user attributes satisfy any rule, the computer system is configured to transmit an offer corresponding to the rule to the client device for display on the web page, or on a next web page (for example if the user interaction is a click that results in a new web page being presented). In this manner, rules are run and offers are updated in real time as a user interacts with a web page.

In one embodiment, each time a user views a page or interacts with a page, the javascript module (or other module or code) is triggered to check rules and recalculate segmentation. The javascript module provides a front-end interface as part of the web page that processes this functionality.

According to one example, a rule requires that a user be referred from Google and views three different pages of a particular web site (e.g., www.cbssports.com) before an offer is displayed. When a user is first referred from the Google search engine to a web page on www.cbssports.com, the javascript module checks to see if the rule is met. In this case, the rule is not met. When the user then clicks on a different page on the www.cbssports.com web site, a javascript module (there may be one javascript module on each web page) again checks to see if the rule is met. After the third web page is reached, the javascript module checks and determines that the rule has been met. In response, the computer system pushes an intercept survey to the user.

The real-time interactions can indicate a context in which the user is operating. User profile database 818 may further comprise user registration data from other web sites (e.g., www.bnet.com, www.cnet.com, etc.) which can be used in determining whether a rule is met for displaying an offer while the user is on www.cbssports.com.

The real-time sources of user attributes, such as from context, segmentation, registrations with other web sites, demographic data, etc. need not occur within a single browsing session. For example, the data warehouse database 816 stores user interaction data going back 30 days (or other periods of time), and this older data may be used in determining whether a rule is met (for example, whether a user visited three different pages on a web site within the 30 day window).

Referring now to FIG. 16, a more detailed flow diagram of the process of targeting offers to users of a web site of FIG. 15 will be described. In response to a user visiting a web page, at block 1602 the ______.js script is loaded on the page. ______.js may be a javascript client and may be loaded at the top of the web page, so that its functions may be started even before web page components are loaded and the web page is built. At a block 1604, to get segments, the web site invokes a data call (called cbsiLoad Data in this embodiment). Block 1606 indicates that content of the web page continues to load while the segments are obtained, which may allow the ______.js module to check the user segmentation attributes without substantially interrupting the transmission of other portions of the web page to the client device.

At a block 1608, ______.js is configured to call engine 822. User identification information is forwarded to engine 822. User identification information can come in one or more of a variety of different forms. For example, the method of FIG. 6 or portions thereof may be used to identify a user. In one embodiment, the ______.js module is configured to retrieve cookies from a client user computer. In another embodiment, data warehouse 816 is configured to store tracking gifs, which may be single-pixel GIFs, transparent GIFs, or clear gifs, which may data warehouse 816 to track general user traffic patterns. Registered users or anonymous (e.g., users who have not signed-in) may be identified, for example using a cookie ID. The user identification may also be sent along with information about the page type that the user is on.

At block 1610, engine 822 is configured to retrieve user attributes from user profile database 818. Engine 822 then compares the user attributes to rules in rules database 824 to determine whether any of the rules are met. If any rules are met, a user segment is set (which may be stored in segment database 820). At block 1614, a real time sessions server (RTSS) is checked to determine, for example, which offers have already been shown to the user and how recently, how many, and/or how long, etc. For example, even if a user's attributes meets a rule to trigger the display of an offer, engine 822 may be configured to not provide the offer if the offer was previously presented to the user. RTSS may also be configured to store the number of page views on a particular website in a particular session. For example, if a rule contains a criterion that requires a user to turn at least five page views on a web site in a particular session, this data can be obtained from the RTSS. RTSS may also provide other functions, such as storing temporary session data (e.g., 30 days maximum, in one embodiment). The temporary session data may be used to store an indication of whether an offer has been shown to a user and when, to assist in preventing the showing of duplicate offers and for frequency capping.

As another example, a rule may require that a user was referred by the Google search engine, have viewed a particular page type at least three times and be an IT executive. If the rule is met, the user is placed in a segment.

At block 1616, the web page module (e.g., javascript module) that called engine 822 receives any segments which meet the criteria set forth in blocks 1610, 1612 and 1614. At block 1618, DVAR values are set in the web browser of the client computer in the variable data portions of the web page being displayed or in other portions of the web page data. At a block 1620, ad server 812 is called to return ads customized or personalized based on the segment data received in block 1616, which are then displayed in the web page. If a more specific ad is not available in ad server 812 for this user segment, an advertisement is selected based on other criteria for display. Block 1620 may be managed by a separate javascript client loaded along with the web page and the ______.js JavaScript client. At block 1622, offers database 814 is called to return other offers customized or personalized based on the segment data received at block 1616. For example, for a javascript overlay, the ______.js module may be configured to trigger where the overlay comes from (e.g., from side, from top, other treatments, etc.). The ______.js module may be configured to keep track of which offers were shown to a user (which may be considered global rules, such as only showing a user X number of offers in Y period of time), by way of its integration with RTSS.

During a subsequent user interaction with the web page, the process repeats beginning at block 1604. The computer system is configured to receive the user interaction with the web page, to update the session data in the memory (e.g., at the RTSS and data warehouse), and to run the rule against the updated session data to determine whether the user meets the rule. In one embodiment, these steps may all occur while the user is still in a current session (i.e. the user has not logged off or left the web site).

If the user interacts with any offer, the computer system is configured to receive the user interactions and to store the user interactions in memory. The computer system may be configured to provide a reporting function, which may report data about offers such as number of views, number of clicks, number of conversions, conversion rate, and opt-outs. The reporting may be done via a dashboard comprising graphical output. The report may be generated and transmitted to a second client device different than the client device.

While some embodiments describe using an ______.js module or other javascript module to make certain calls to the server, the web page itself may be configured to make calls to the web servers with similar functionality.

The teachings herein may be used on a server configured to serve mobile devices, for example where the content is specifically configured for a web browser on a mobile device.

Referring now to FIG. 17, a computer system for targeting offers to a user of a web site will be described, according to another exemplary embodiment. The example of a fantasy league marketing offer will be used to describe an exemplary flow with reference to the platform of FIG. 17. A segmentation creation tool 1701 is run by a product manager or product marketer to create one or more market segments. For example, a segment may be a registered user who purchased a fantasy league product on the web site within the past two years. This segment may be titled “prior fantasy purchaser.” The prior fantasy purchaser segment may be created and stored in a data warehouse database 1703. The product manager would then go into the offer and rule creation tool 1705 to define a campaign program and attributes of an offer. The segment ID for “prior fantasy purchaser” and any additional rules are created in the rule builder section of the tool. An example of a rule in this scenario would be whether the “prior fantasy purchaser” segment also visited the fantasy football website in the past seven days. The offer metadata itself is saved in the offer database 1707. The rules are deployed into a centralized version of the open sourced Arrow module 1709. In one embodiment, Arrow module 1709 is made open source to make it useable across business units of an organization.

The product manager also goes into the ad engine campaign tool 1711 and traffics or enters a copy of their creative (e.g. comprising HTML, text, etc.) into database 812. Marketing offers may be defined in the advertising database 1713 using the module 1711. Surveys and intercepts may be defined using offer and rule creation tool 1705. An ______.js module 1715 is added to web pages. When a web page loads, ______.js module 1715 is fired as a non-blocking call to engine 1717.

Engine 1717 is called which in turn calls the user profile database 1719. User segments and pageview information is obtained from the user profile database 1719. Pageview information may comprise a request to load an HTML page. Pageview information may also comprise other user interactions with a web page, page type, referring URL, search term that the user entered into a search engine to find the page, etc. Database 1719 receives segment data periodically (e.g., nightly) from data warehouse database 1703 and receives real-time user data from real-time data source 1721. Engine 1717 further retrieves information from real-time session server 1723 to obtain information useful for frequency capping (e.g., assuring a user does not receive more than X of the same or similar offer within Y period of time or pageviews).

The engine 1717 fires the rules through the rules engine 1709, the results of which are passed back through engine 1717 to ______.js module 1715 thereby setting dvar values in the browser. The dvar values are also set in the advertisement module 1725, which pulls ads from the ad server 1713 and presents them to the user. If the engine 1717 does not have ads defined for the web page or otherwise has surveys or intercepts triggered by the rules from rules database 1709, a call is made to the offers database 1707 and engine 1717 then becomes a delivery engine and delivers overlays for pop-ups or other offers on the page.

Referring now to FIG. 18, a block diagram of an architecture for a user profile database will be described. User profile database 1800 is configured to capture and store user attribute data (in the form of user profiles) from a plurality of web sites and to provide access to the user attribute data to internal clients 1802, which may comprise any of a number of types of clients. Internal clients may refer to clients internal to a business organization, including business units within the business organization. The data may be accessed via a real-time application programming interface (API). Database 1800 may be configured to modify, reformat, normalize, merge, distill, aggregate, or otherwise organize raw data from a plurality of sources 1804 into formats more readily useable by clients 1802.

Database 1800 may be configured to organize by user over hundreds or over thousands of user events every second, such as web page views, keywords entered, user clicks, or other events from a large community of web site users. Source 1806 may comprise user data from a user registration system (URS) from any of a plurality of web sites, and from web site-specific databases, for example from a noSQL database. Source 1808 may comprise user page view, click and keyword data from one particular business unit (CBS Interactive, Inc.) within a business organization (CBS Corp.) representing a plurality of web sites (www.cnet.com, www.bnet.com, www.cbssports.com, etc.). Sources 1806 and 1808 may comprise historical data (e.g., data older than a predetermined period of time, such as at least 30 seconds, at least 30 minutes, at least one day, etc.). Source 1810 may comprise real-time data representing user clicks or other streaming data (e.g., data newer than a predetermined period of time, such as less than 30 seconds, less than 30 minutes, etc., or data stored in a cache memory, etc.). The streaming data may be provided via an ActiveMQ open source messaging and integration pattern system, provided by the Apache Software Foundation, Forest Hill, Md. Source 1812 may comprise user segmentation data, which may comprise segment IDs representing one or more marketing segments that a user belongs to based on any of a number of user attributes. Source 1814 may comprise geographic location information, such as country, state, city, latitude/longitude, internet service provider (often one's employer), or other geo-location, which may be retrieved using an internet protocol data acquisition service that determines location and other information based on IP address. Source 1816 indicates that database 1800 may receive data from a wide variety of additional sources internal to the business organization or external thereto, for example, from a travel website such as www.travelocity.com. The front end, or highest level of database 1800 may be configured to simultaneously contact any number of databases, so that more databases can be easily added. The system have built in support to add additional data sources. Once added, the data from those source becomes available to the rules engine for consideration in rules.

The compilation of user attribute data into profiles accessible via database 1800 may be accessed by other applications to assist in targeting users by market segment or otherwise for offers. In one embodiment, an application may be configured to identify a historical pattern for a particular user, determine new content available at a web site that is relevant to the historical pattern and provide to the user a link to the content, for example in a portion of a web page requested by the user. In another embodiment, an application may be configured to generate a segment based on the attribute data in database 1800. A segment may be a segment called “Yahoo frequent user” and may be defined as a user who has viewed three pages on the web site and who was referred from Yahoo's search engine.

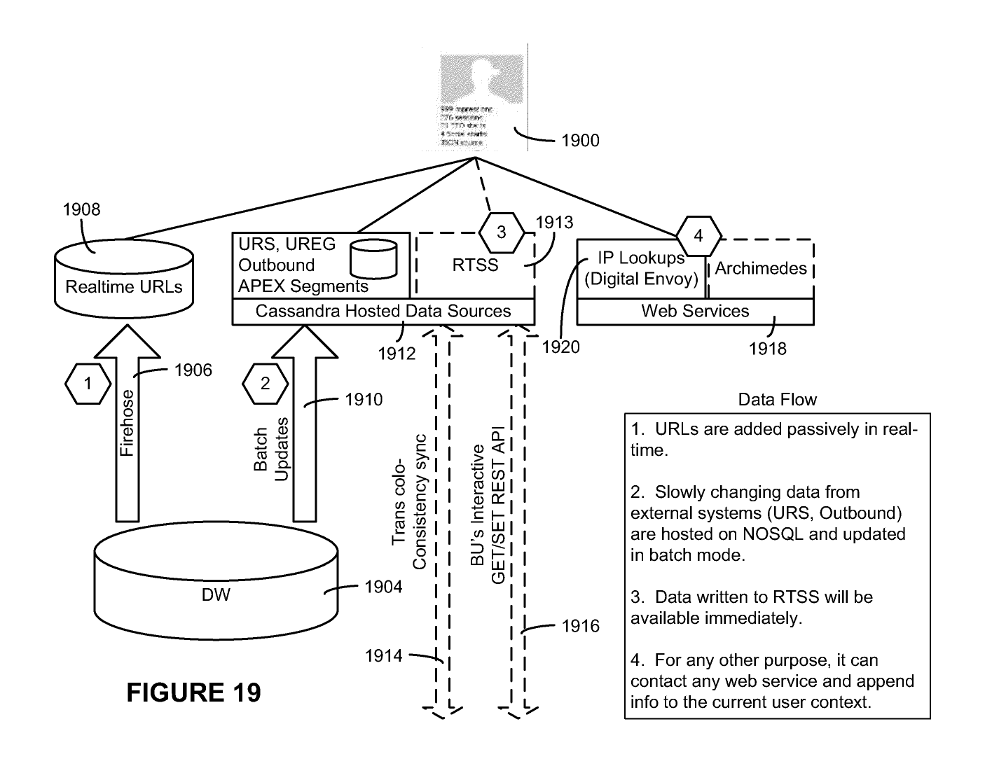

Referring now to FIG. 19, a more detailed block diagram of one embodiment of the architecture of FIG. 18 will be described. Block 1902 represents a user profile for a particular user. Data warehouse database 1904 (similar to database 816 in FIG. 8) stores both real-time data and historical data for users. A first data source 1906 provides real-time URLs 1908 of web sites visited by a user as they move about a web site. This real-time data is added passively to database 1800. A second data source 1910 provides batch updates of data which is more slowly changing (e.g., historical data). These batch updates may be provided from any of a plurality of systems external to data warehouse 1904 such as a first user registration system URS and a second, different user registration system UREG (i.e., a single user may have different usernames and passwords in each different user registration system for different web sites, though both user registration systems may operate on a similar user registration platform). Batch updates may further be provided by an e-mail managements system, a newsletter system, and a segment database such as the segment database described hereinabove. In this exemplary embodiment, the batch updates are stored using an open source SQL database 1912, such as a Cassandra database, provided by the Apache Software Foundation, Forest Hill, Md. Other sources of user data comprise RTSS data 1913, such as from a trans co-located consistency synchronization source 1914 or from one or more interactive get/set REST (representational state transfer) API sources 1916 maintained by different business units within an organization. RTSS data 1913 is immediately available to database 1800. Data sources may also comprise one or more different web services 1918, such as an IP lookup using an IP lookup service 1920, an audience database provided by Blue Kai, Inc., Bellevue, Wash. or by Audience Science, Bellevue, Wash. Database 1800 can contact web services 1918 and append user attribute data from those services to a current user profile/context.

As illustrated in FIGS. 18 and 19, older historical data, typically received in batch updates, is stored in user profiles or contexts along with immediate, short-term data. Typically, the storage areas for these two different types of data are different. Recent data is typically stored in a memory, buffered, and held for a certain period of time, and then called off-line and saved to disk. A short-term memory cache may be flushed every thirty seconds in one embodiment. A Memcache protocol may be used, which is a general purpose distributed memory caching system, for the purpose of grafting real-time data on historical data.

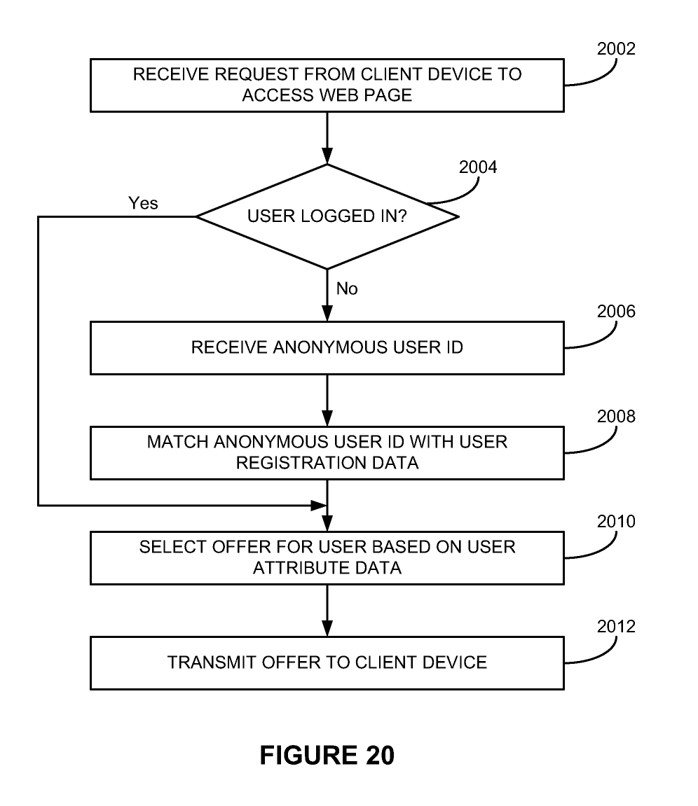

Referring now to FIG. 20, a method for providing an offer on a web page to a user will be described, in which an anonymous ID is matched up with a registration account to better track a registered user who uses the web site anonymously (e.g., without logging in). A memory is configured to store user registration data (e.g., in the form of a user account, which may comprise username, password, and other user data) and user attribute data for a user registered to use a web site. At step 2002, a processing circuit is configured to receive a request from a client device to access a web page on the web site. At block 2004, the processing circuit determines whether the user is currently logged-in to a user account. At block 2006, the processing circuit determines that a request for a web page is received during a session in which the registered user is not logged in to the web site and therefore receives and stores an anonymous user ID for the user, such as temporary ID, cookie, or other identifier. The temporary ID may be received as part of a request message to access a web page. At block 2008, the processing circuit matches the anonymous user ID with the user registration data for the registered user. For example, when a user logs in to a web site, the web site may store a cookie on the user's computer and store an association of the cookie with the user's registered ID. The next time the user logs in anonymously with the same computer (assuming cookies have not been cleared), the processing circuit uses the cookie to determine that the user is the same user as that associated with the registered ID. With the IDs matched, the user attribute data for the user can be updated with new information received while the user is operating anonymously (for example, pageviews, interactions with advertisements, etc.). At block 2010, the system selects an offer for the user based on the user attribute data for the registered user, for example as describe above with reference to FIGS. 15 and 16. At block 2012, the selected offer or offers are transmitted to the client device.

The embodiments described herein are generally described with reference to targeting offers. However, the teachings herein may also be applied to targeting non-offer content, such as news articles, opinion pieces, commentary, or other textual or graphical content.

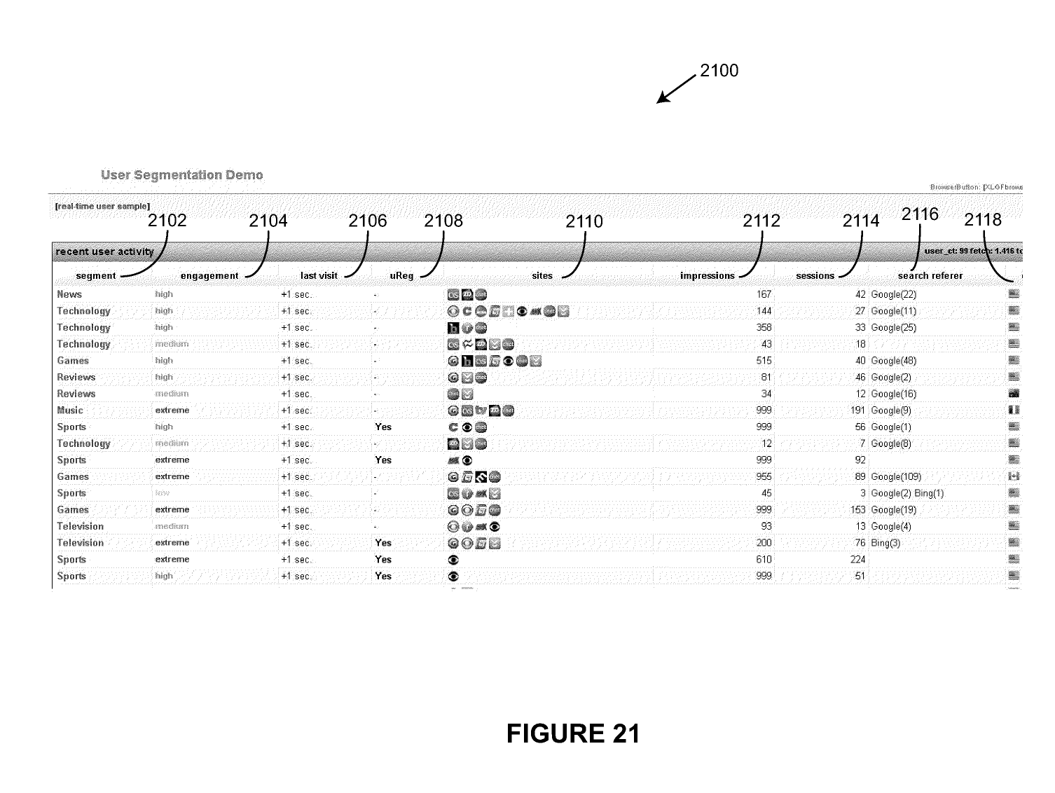

Referring now to FIG. 21, an illustration of user profile data stored in database 1800 will be described. Data set 2100 comprises 18 data entries obtained over a period of much less than one second, each data entry representing a change in a user profile attributable to a new pageview or other real-time attribute update. Columns are provided to indicate the type of data being stored for users. A column 2102 lists segments that a user may be associated with, in this case representing a most commonly used type of content by the user (e.g., news, technology, games, reviews, music, sports, technology, etc.). A column 2104 lists a level of engagement for the user associated with the event, which may be based on different thresholds of impressions per period of time and/or based on a number of sessions in a period of time, to arrive at engagement levels (e.g., low, medium, high, extreme, etc.). Column 2106 indicates a time of last visit to a CBS Interactive web page, all of which are less than one second ago in this case because these events were chosen based on a most recent flow of real-time data. Column 2108 indicates whether the user associated with the event is a registered user. Sites column 2110 indicates which of the different CBS Interactive web sites a user has accessed within a predetermined period of time (e.g., 30 days). Impressions column 2112 indicates the number of pageviews or impressions the user has made on all CBS Interactive web sites combined within the predetermined period of time, capped at 999. Sessions column 2114 indicates the number of distinct sessions a user has started on all CBS Interactive web sites combined within the predetermined period of time. Search referrer column 2116 indicates the referring site for the site having the largest number of referrals to a new session in a CBS Interactive web site, with the number of sessions referred out of the total sessions in sessions column 2114 being shown in parenthesis. A country column 2118 shows a flag associated with the geolocation of the user at the time of the event, the geolocation data being obtained from an IP data source.

The data in the user profile database may be retained for the predetermined period of time, which may be at least four weeks, at least six weeks, at least eight weeks, etc. The database acts first-in-first-out in this exemplary embodiment.

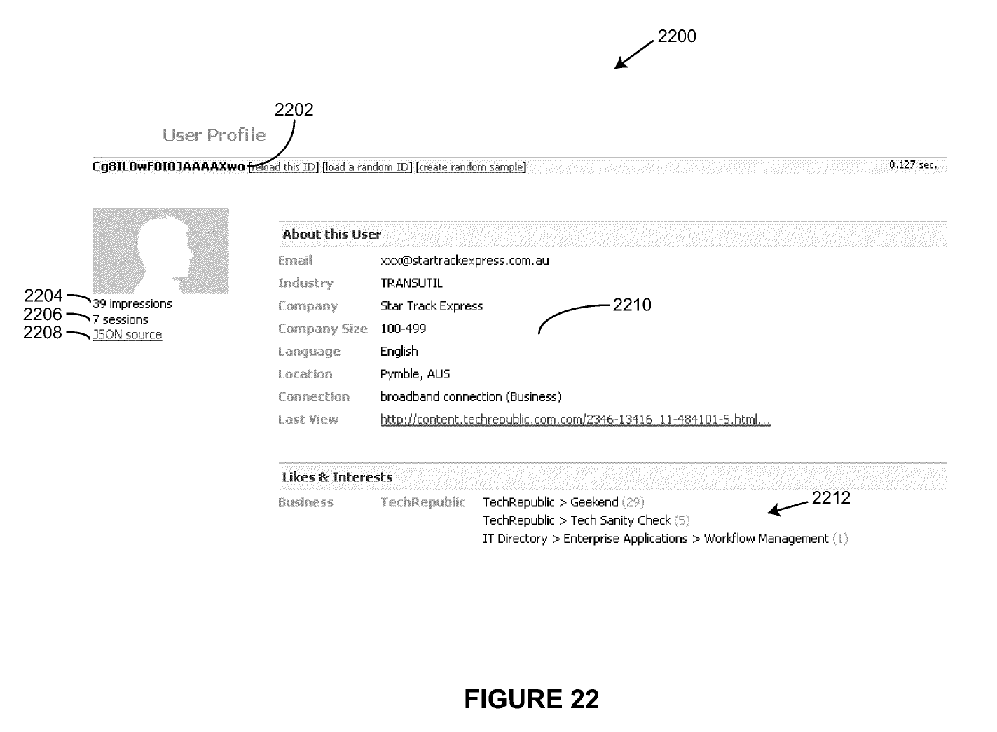

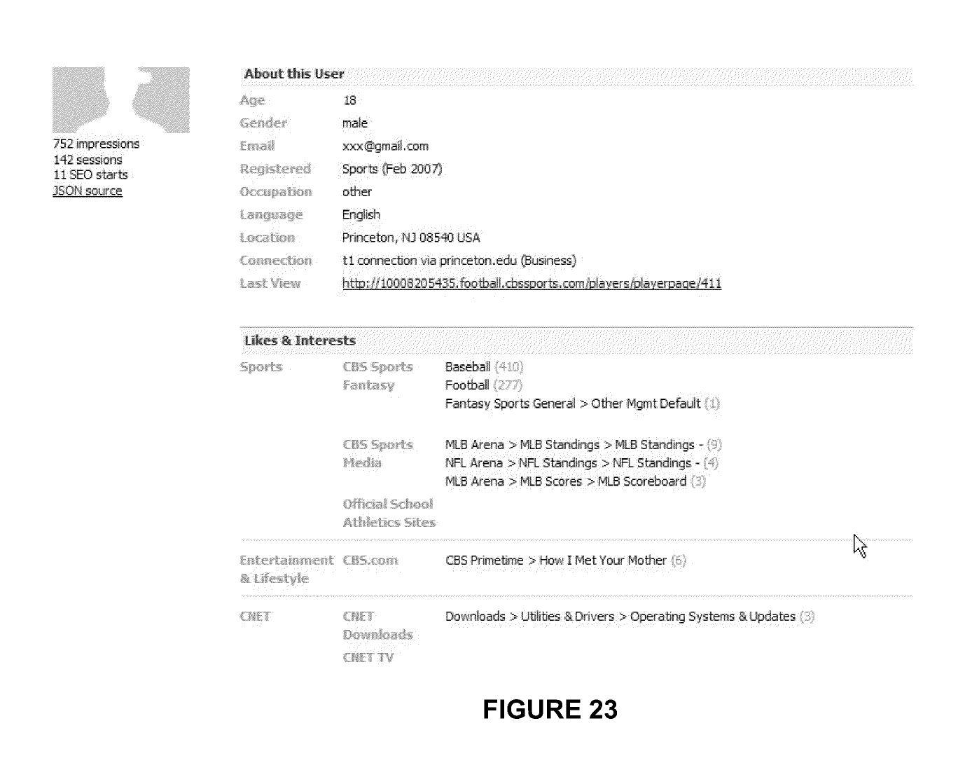

Referring now to FIG. 22, an illustration 2200 of user profile data for a particular user will be described. A user ID 2202 is shown for a particular user. User profile database may receive the user ID as a search term and respond with data shown in the illustration 2200. The user profile may show a number of impressions 2204, a number of sessions 2206. A link 2208 is shown to link to the textual javascript data used to assembly this illustration of the profile data. Additional user attribute data 2210 is shown. Likes & Interests of the user 2212 are also stored in the user profile. FIG. 23 shows another example of a user profile.

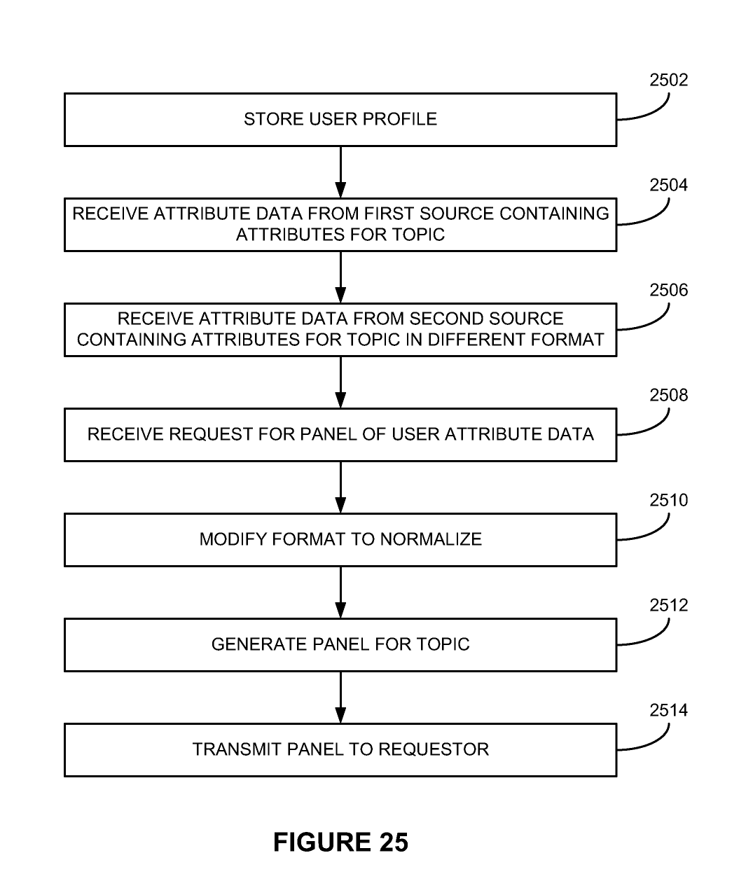

Referring now to FIG. 25, a flowchart of a method of reporting user attributes by topic in a plurality of different topical reporting panels will be described. A panel may comprise a set of data about a particular user that expresses something about the user's behavior or affinity. The panel may cross-correlate user data across multiple web sites. The panel may generate calculated values based on discrete data items about the user's behavior. At step 2502, a user profile is stored in a memory, such as database 1800. At steps 2504 and 2506, a processing circuit is configured to receive user attribute data from a plurality of different sources in a plurality of different formats. At step 2508, the processing circuit receives a request from a requestor for user attribute data by topic (e.g., games, sports, etc.). At step 2510, the user attribute data is modified in format to normalize the data received in different formats from different sources. For example, when the user attribute data comprises a genre ID for a music genre, and the different sources store the genre ID in different formats, the modification normalizes the different genre IDs so that the data can be reported in a music panel. At step 2512, the processing circuit generates a panel of user attribute data associated with the topic from at least the modified user attribute data. At step 2514, the processing circuit transmits the panel to the requestor, which may then be displayed or otherwise used for further analysis.

A panel generation module may be used to look up information a user has generated in their impression history and correlate that to content-specific descriptions, topic names, or other types of information particular to the URLs the user has visited. The panel generation module may be configured to receive a user ID and to look up user information based on the user ID. In one application, when a user visits a web site, the web site queries database 818 based on the user's ID and retrieves information about the user's behavior. For example, if a user has been to many different URLs on www.gamespot.com, the system can generate a mapping from those URLs that is presented in a panel of what kind of user the user is on www.gamespot.com, for example, whether the user is a PlayStation2 player, Xbox player, Wii player, etc. These or other user attributes may be used to differentiate users of the www.gamespot.com web site, using a gamespot-specific panel. The users may also be differentiated based on game type (e.g., action game, children's game, etc.). Data may be transformed from a user history into some other kinds of values. Any data that may give some understanding about the user may be used to generate a panel. The panel provides a terse way of presenting user affinity. Numeric quantities may be repackaged as or converted to more reader-friendly strings such as Xbox, Wii, www.gamespot.com, etc.

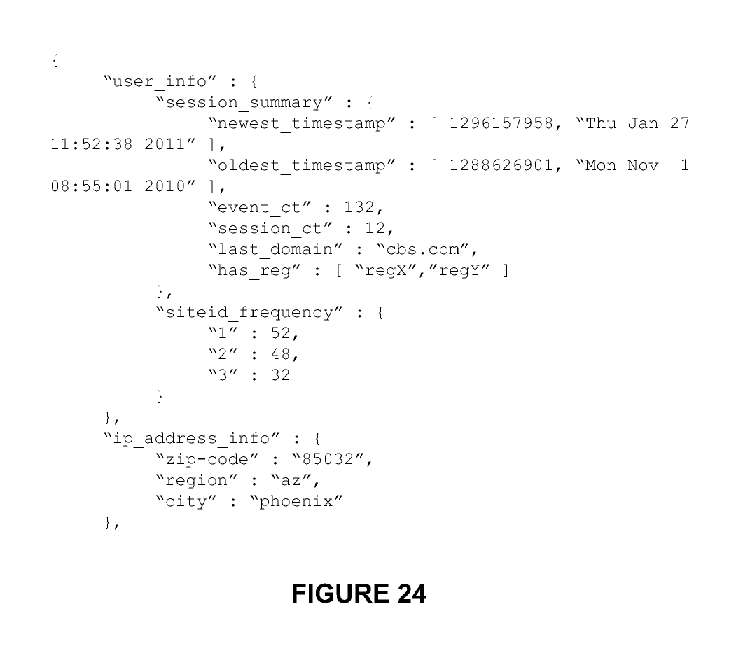

FIG. 24 discloses an exemplary panel. This series of panels integrates two resources (user_info and ip_address_info) with the user_info exhibiting two different clusters of information. One cluster of information is session_summary information and the other cluster of information is sitid_frequency. session_summary provides a high level of general user session information. session_summary may comprise a newest_timestamp indicating a most recent time and date of a user impression on any of the sites being cross-correlated and an oldest_timestamp indicating an oldest time and date of a user impression. event_ct may comprise a total number of impressions or other events for the user. session_ct may comprise the total number of unique sessions. last_domain may comprise the URL which was last visited by the user. has_reg may indicate whether the user is registered for any of the sites and for which sites the user is registered, which may be keyed off a single user_ID. Each web site is coded with a site ID, e.g., “1”, “2”, “3”, etc. siteid_frequency indicates the number of impressions by this user on each of sites 1, 2 and 3, in this case 52, 48 and 32, respectively. The different sites may be www.cnet.om, www.zdnet.com, etc. ip_adress_info may comprise zip code, region, city, etc. which is retrieved from another source based on the IP address of the user using the web site. Other data may further be drawn in to the user panel.

The panel may be used in a number of different scenarios. For example, managers of web sites may use the user information received on panels to build survey or intercept campaigns; the panels may also be used in real-time when a user visits a site to trigger a rule, push an offer, etc. In an organization having a plurality of different web sites, a user panel from one site may be used to cross-promote other web sites.

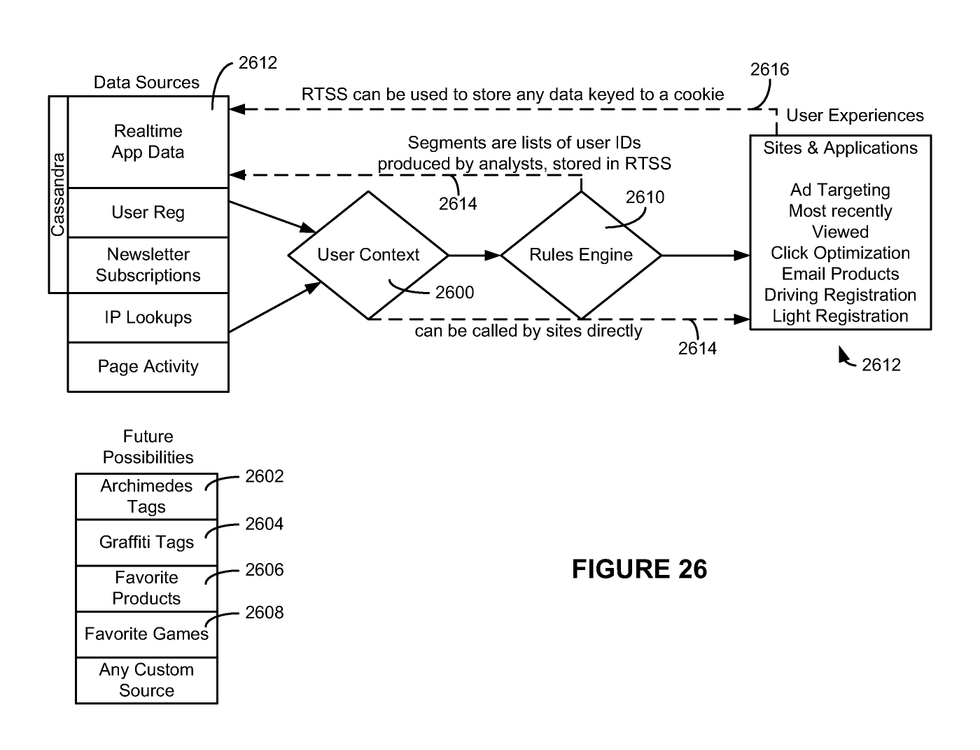

Referring now to FIG. 26, a user profiling architecture will be described according to an exemplary embodiment. Many of the process flows and data sources illustrated in FIG. 26 are similar to those described with reference to FIGS. 8 and 17-19. Other data source that may be used to create the user context 2600 include Archimedes tags 2602 and Graffiti Tags 2604, and user favorites such as products 2606 and games 2608, which may be determined from products purchased or games played, user input, or other methods. Graffiti Tags 2604 may come from a Graffiti tool, which is a tool that can provide auto generated meta data about a web page. This data could be returned about a page that a user had visited and be targeted against in the future. The user context database 2600 may be called by the rules engine 2610 or directly by one or more web sites or applications 2612, as indicated by arrow 2614. Rules engine 2610 may be configured to apply rules to user segments, which may comprise lists of user IDs produced by analysts and stored in RTSS 2612, as shown by arrow 2614. Arrow 2616 indicates that RTSS 2612 can store any data keyed to a cookie from the sites and applications. The sites and applications include ad targeting, most recently viewed, click optimization, e-mail products, driving registration and light registration. Light registration may comprise a registration process which requires less information from a user than driving registration. Rules engine 2610 comprises a targeting engine that provides rule creation, javascript delivery, tracking and/or reporting, in various embodiments. RTSS is a service that allows web applications to write real-time user session data, which can then be ready by the system and associated with a user profile.

It should be noted that the server is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on 25 media. The phrase “computer system”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer system for targeting offers to users of a web site, comprising:
a memory configured to store a plurality of user attributes for a user and a plurality of rules defining when an offer is to be presented to a user; and
a processing circuit configured to transmit a web page to a client device, to receive user interaction data from the client device representing interaction with the web page, to update the user attributes stored in memory in response to the received user interaction data, to determine whether the updated user attributes satisfy a rule, and based on whether the updated user attributes meet the rule to transmit an offer to the client device for display on the web page or a next web page.

2. The computer system of claim 1, wherein the offer is one of an intercept, an offer for a sports-related product or a survey.

3. The computer system of claim 1, wherein the offer is a survey.

4. The computer system of claim 1, wherein the user attributes comprise session data representing user interaction with a web site during a session, a external site referral data representing a site other than the web site which referred the user to the web site, registration data representing data received about the user during a registration process, and site-specific data.

5. The computer system of claim 1, wherein the processing circuit is configured to receive a user interaction with the web page, to update the session data in the memory, and to run the rule against the updated session data to determine whether the user meets the rule.

6. The computer system of claim 5, wherein the processing circuit is configured to receive the user interaction, update the session data and run the rule all while the user is still in a current session.

7. The computer system of claim 1, wherein the processing circuit is configured to check whether an offer was previously presented to a user before including the offer in the web page.

8. The computer system of claim 1, wherein the processing circuit is configured to receive user interactions with the offer and to store the user interactions.

9. The computer system of claim 8, wherein the processing circuit is configured to generate a report based on the stored user interactions and to transmit the report to a second client device.

10. The computer system of claim 9, wherein the report comprises views, clicks, conversions, a conversion rate and opt-out data.

11. The computer system of claim 1, wherein the processing circuit is configured to check the user segmentation attributes without interrupting the transmission of other portions of the web page to the client device.

12. A computer system for targeting offers to users of a web site, comprising:
a memory configured to store a plurality of user attributes for a user and a plurality of rules defining when an offer is to be presented to a user, the user attributes comprising demographic data for the user, session-based user data representing a current user session and historical information about the user; and
a processing circuit configured to transmit a web page to a client device, to compare a rule to the demographic data, session-based user data and historical information to determine whether these user attributes meet a rule, and based on whether the user attributes meet the rule to transmit an offer to the client device for display on the web page.

13. The computer system of claim 12, wherein the offer comprises a survey.

14. The computer system of claim 12, wherein the session-based user data comprises a number of page views of a particular page type.

15. The computer system of claim 14, wherein the number of page views is based at least in part on a page being currently displayed to the user in response to receiving a user request for the page.

16. A computer system for generating a rule-based marketing offer for a web site, comprising:
a memory; and
a processing circuit configured to transmit to a client device a web page comprising fields for receiving an identification of a rule, customer segment identification, and an offer identification, to generate a module based on the received identifications and to store the module in association with a web page.

17. The computer system of claim 16, wherein the processing circuit is configured to generate the module to retrieve customer segment data from a customer segment database based on the customer segment identification.

18. The computer system of claim 16, wherein the module is transmitted to a client device along with a web page.
